(19) United States
(12) Patent Application Publication
(10) Pub. No.: US 2015/0010666 A1
(43) Pub. Date: Jan. 8, 2015

(54) DROPLET GENERATING DEVICE

(71) Applicant: NITTO DENKO CORPORATION, Ibaraki-shi, Osaka (JP)

(72) Inventors: Shinsuke Sugiura, Ibaraki-shi (JP); Kenjiro Saomoto, Ibaraki-shi (JP); Shinji Sugawara, Ibaraki-shi (JP); Eriko Abe, Ibaraki-shi (JP); Masao Nakagawa, Ibaraki-shi (JP)

(73) Assignee: NITTO DENKO CORPORATION, Ibaraki-shi, Osaka (JP)

(21) Appl. No.: 14/129,353

(22) PCT Filed: Mar. 27, 2013
(86) PCT No.: PCT/JP2013/059070

§ 371 Date: Dec. 26, 2013

(30) Foreign Application Priority Data
Mar. 29, 2012 (JP) 2012-076082

(51) Int. Cl. B01J 2/06; B01F 3/08

(52) U.S. Cl. CPC B01J 2/06; B01F 3/0807
USPC 425/6

(57) ABSTRACT

A droplet formation device 1 includes: a base member 2 formed of stacked substrates including a middle substrate 21 and a lower substrate 23; a passage structure 211 formed on the middle substrate 21 and including droplet formation passages through which a liquid dispersed-phase material and a liquid continuous-phase material flow to form droplets of the dispersed-phase material using a shear force of the continuous-phase material; a liquid storage part 231 formed on the lower substrate 23 and storing the liquid dispersed-phase material 200 and the liquid of the continuous-phase material 100; dispersed-phase material supply parts through which the liquid dispersed-phase material 200 is supplied from the liquid storage part 231 to the droplet formation passages of the passage structure 211; and continuous-phase material supply parts through which the continuous-phase material 100 is supplied from the liquid storage part 231 to the droplet formation passages of the passage structure 211.

### TECHNICAL FIELD

The present invention relates to a droplet formation device for forming droplets to produce gelatin particles and the like.

### BACKGROUND ART

Conventionally, there has been known a droplet formation device including droplet formation passages through which a dispersed-phase material (a disperse phase of an emulsion, such as gelatin) and a continuous-phase material (a disperse medium of the emulsion, such as oil) flow to form droplets of the dispersed-phase material using a shear force of the continuous-phase material (for example, see Patent Literature 1).

From the thus formed droplets, small particles are produced for use in embolization, drug delivery systems (“DDS”), and the like.

In the above-described conventional droplet formation device, a plurality of substrates on each of which a passage structure constituted by a plurality of droplet formation passages is formed are stacked on one another, and the stacked substrates are secured while being sandwiched by cover members, packings and the like, and further sandwiched by a pair of plate-like pressing members with respect to a vertical direction. A continuous-phase material and a dispersed-phase material are supplied to the passage structure formed on each substrate. The continuous-phase material and the dispersed-phase material are respectively supplied through a supply passage for the continuous-phase material and a supply passage for the dispersed-phase material, which are provided outside the space between the pair of pressing members, and through respective supply paths penetrating the pressing members and the substrates.

### CITATION LIST

### Patent Literature

Patent Literature 1: Japanese Unexamined Patent Publication No. 2008-238097

### SUMMARY OF INVENTION

### Technical Problem

The above-described conventional droplet formation device includes, in addition to a base member formed of the pressing members and the substrates, the supply passage for the continuous-phase material and the supply passage for the dispersed-phase material which are provided outside the base member, and this increases the number of components of the device. If a problem such as clogging of a supply path or of a droplet formation passage occurs, it is necessary to disassemble the droplet formation device to clean the supply path or the like; however, the above structure makes it difficult to disassemble and assemble again the droplet formation device. Further, in the above-described conventional droplet formation device, the supply passage for the continuous-phase material and the supply passage for the dispersed-phase material are provided outside the base member, and this complicates the manner of providing the supply paths for supplying the dispersed-phase material and the continuous-phase material from the supply passages to the droplet formation passages. For example, the supply paths have to be inserted into through holes formed in the pressing members and the substrates, and thus, the manner of providing the supply paths is complicated. This also makes it difficult to disassemble and assemble the droplet formation device.

To solve the above-described problems, an object of the present invention is to provide a droplet formation device easily disassembled and easily assembled.

### Solution to Problem

A droplet formation device of the present invention includes: a base member formed of a plurality of substrates including a first substrate and a second substrate; a passage structure including a plurality of droplet formation passages through which a liquid of a dispersed-phase material and a liquid of a continuous-phase material flow to form droplets of the dispersed-phase material by using a shear force of the continuous-phase material, the droplet formation passages being formed on the first substrate; a dispersed-phase storage part which is formed on the second substrate and is configured to store the liquid of the dispersed-phase material; a continuous-phase storage part which is formed on the second substrate and is configured to store the liquid of the continuous-phase material; dispersed-phase material supply parts through which the dispersed-phase material is supplied from the dispersed-phase storage part to the droplet formation passages of the passage structure; and continuous-phase material supply parts through which the continuous-phase material is supplied from the continuous-phase storage part to the droplet formation passages of the passage structure.

In the above structure, the dispersed-phase storage part and the continuous-phase storage part are formed on the same single substrate (on the second substrate). Meanwhile, the passage structure is formed on the first substrate. Thus, the main elements for forming the droplets are formed on the two substrates which are the first substrate and the second substrate, and this allows the droplet formation device to have a smaller number of components, and to be easily disassembled and easily assembled. Further, the dispersed-phase storage part and the continuous-phase storage part are formed in the base member. Therefore, the manner of providing the dispersed-phase material supply parts and the manner of providing the continuous-phase material supply parts are simplified, compared with a conventional art where: elements corresponding to these storage parts are provided outside the base member; and the continuous-phase material supply part for supplying the continuous-phase material from the continuous-phase storage part to each droplet formation passage of the passage structures and the dispersed-phase material supply part for supplying the dispersed-phase material from the dispersed-phase storage part to each droplet formation passage of the passage structures are provided so as to pass the respective through holes in the base member. This also allows the droplet formation device to be easily disassembled and easily assembled.

In the above droplet formation device, the passage structure may include a plurality of passage structures. Further, the continuous-phase storage part may include a plurality of the continuous-phase storage parts which are formed on the second substrate and are configured to the continuous-phase material to be supplied to the plurality of passage structures, and the dispersed-phase storage part may include a plurality of the dispersed-phase storage parts which are formed on the second substrate and are configured to the dispersed-phase material to be supplied to the plurality of passage structures.

In the above structure, the plurality of passage structures are formed in the droplet formation device to improve productivity per unit time in forming the droplets in the droplet formation device, and the plurality of continuous-phase storage parts and the plurality of dispersed-phase storage parts for the plurality of passage structures are collectively formed on the single substrate which is the second substrate. This allows the droplet formation device to have high productivity per unit time in forming the droplets, and to be easily disassembled and easily assembled.

The droplet formation passages in the passage structure may be arranged annularly. In addition, each of the continuous-phase storage part and the dispersed-phase storage part is formed on the second substrate into a substantially circular shape in a plan view so as to correspond to an arrangement of the droplet formation passages.

With the above structure, the annular arrangement of the droplet formation passages allows a larger number of droplet formation passages to be arranged in a space-saving manner, compared with a conventional manner in which the droplet formation passages are arranged in parallel to one another. Further, since each of the continuous-phase storage part and the dispersed-phase storage part is formed into the shape corresponding to the arrangement of the droplet formation passages (i.e., into the substantially circular shape in a plan view), each of the continuous-phase storage part and the dispersed-phase storage part is formed on the second substrate with the possible smallest size. Thus, while a larger number of droplet formation passages are arranged, the droplet formation passages, the continuous-phase storage part, and the dispersed-phase storage part are formed in a space-saving manner. This allows the liquid formation unit to have high efficiency per unit time in forming the droplets and to achieve downsizing.

The dispersed-phase material supply parts and the continuous-phase material supply parts may be through holes formed in the first substrate or the second substrate. In this structure, the dispersed-phase material and the continuous-phase material are respectively supplied from the dispersed-phase storage part and the continuous-phase storage part to the plurality of droplet formation passages after flowing through the through holes (through the dispersed-phase material supply part and the continuous-phase material supply part). Thus, the dispersed-phase material supply part and the continuous-phase material supply part are also formed in the first substrate or in the second substrate, and this eliminates the necessity to provide, to the base member, a supply path for supplying the continuous-phase material to the droplet formation passages as a separate member. This further facilitates disassembling and assembling of the liquid formation unit.

In the droplet formation device, the passage structure may include a plurality of passage structures on a same horizontal plane. In the conventional art, the passage structures are arranged in the vertical direction, and a single discharge path is shared with the passage structures. In this structure, however, it is likely that, in the discharge path, a droplet discharged from an upper passage structure collides with another droplet discharged from a lower passage structure.

To the contrary, in the above-described arrangement, it is easy to provide, for each passage structure individually, a discharge path through which the droplets of the dispersed-phase material formed through the passage structure are discharged to the outside of the base member, and collision of the droplets formed through the different passage structures is effectively suppressed.

A discharge path through which the droplets of the dispersed-phase material formed through the droplet formation passages of the passage structure are discharged to an outside of the base member may be formed in the base member so that the discharge path corresponds to the passage structure in number. In this structure, the single discharge path is shared with the plurality of droplet formation passages, leading to space saving since a plurality of discharge paths are not respectively formed for the droplet formation passages.

The discharge path includes a first discharge path which is a through hole formed in the first substrate, and a second discharge path which is a through hole formed in the second substrate. In this structure, the discharge path is formed in the first substrate and the second substrate. This eliminates the necessity to provide the discharge path, as a separate member, to the base member. This further facilitates disassembling and assembling of the liquid formation unit.

### Advantageous Effects of Invention

In the above structure, the main elements for forming the droplets are formed on the two substrates which are the first substrate and the second substrate, and this allows the droplet formation device to have a smaller number of components, and to be easily disassembled and easily assembled. Further, the dispersed-phase storage part and the continuous-phase storage part are formed in the base member. Therefore, the structure of the dispersed-phase material supply parts and the structure of the continuous-phase material supply parts are simplified, compared with a conventional art where: elements corresponding to these storage parts are provided outside the base member; and the continuous-phase material supply part for supplying the continuous-phase material from the continuous-phase storage part to each droplet formation passage of the passage structures and the dispersed-phase material supply part for supplying the dispersed-phase material from the dispersed-phase storage part to each droplet formation passage of the passage structures are provided so as to pass the respective through holes in the base member. This also allows the droplet formation device to be easily disassembled and easily assembled.

### BRIEF DESCRIPTION OF DRAWINGS

FIG. 1 is a perspective view of a droplet formation device of an embodiment.

FIG. 2 is an exploded view of the droplet formation device of the embodiment.

FIG. 3(a) is a plan view of the droplet formation device of the embodiment, and FIG. 3(b) is a side view of the droplet formation device of the embodiment, viewed from the front.

FIG. 4 is a plan view of a lower substrate.

FIG. 5(a) is a plan view of a droplet formation module of the embodiment, and FIG. 5(b) is a sectional view of the droplet formation module taken along a line J-J in FIG. 5(a).

FIG. 6 is a plan view of the lower substrate of the droplet formation module.

FIG. 7 is a perspective view of a liquid formation unit shown in FIG. 5(a).

FIG. 8 is a plan view of the liquid formation unit, showing the schematic structure of the liquid formation unit.

FIG. 9(a) is a sectional view of the liquid formation unit taken along a line A-A in FIG. 8, and FIG. 9(b) is a sectional view of the liquid formation unit taken along a line B-B in FIG. 8.

FIG. 10 is a sectional view of the liquid formation unit taken along a line C-C in FIG. 8.

FIG. 11 is a sectional view of the liquid formation unit taken along a line D-D in FIG. 8.

FIG. 12 is a sectional view of the liquid formation unit taken along a line E-E in FIG. 8.

FIG. 13 is a sectional view of the liquid formation unit taken along a line F-F in FIG. 8.

FIG. 14 is a sectional view of the liquid formation unit taken along a line G-G in FIG. 8.

FIG. 15 is an explanatory diagram showing a process of producing small particles using the liquid formation unit.

FIG. 16 is an explanatory diagram showing a process of forming droplets using the liquid formation unit.

FIG. 17 is a block diagram showing an electrical structure of a droplet formation system.

FIG. 18 is a flow chart showing an example of a temperature adjustment process executed by the droplet formation system.

FIG. 19 is a flow chart showing an example of a liquid feed process executed by the droplet formation system.

FIG. 20(a) is a plan view of a droplet formation device of a first modification of the embodiment, and FIG. 20 (b) is a side view of a base member of the droplet formation device of the first modification.

FIG. 21 is an exploded view of a droplet formation module of the first modification.

FIG. 22 (a) is a plan view of a droplet formation device of a second modification of the embodiment, and FIG. 22 (b) is a side view of a base member of the droplet formation device of the second modification.

FIG. 23 is a sectional view of a droplet formation module taken along a line L-L in FIG. 22(a).

FIG. 24 is a plan view of a droplet formation passage of another modification of the embodiment.

FIG. 25 is a plan view of a droplet formation passage of another modification of the embodiment.

FIG. 26 is a plan view of a droplet formation passage of another modification of the embodiment.

FIG. 27 is a plan view of a liquid formation unit of another modification of the embodiment.

### DESCRIPTION OF EMBODIMENTS

The following describes a preferred embodiment of the present invention, with reference to the drawings.

(Overview of Droplet Formation Device)

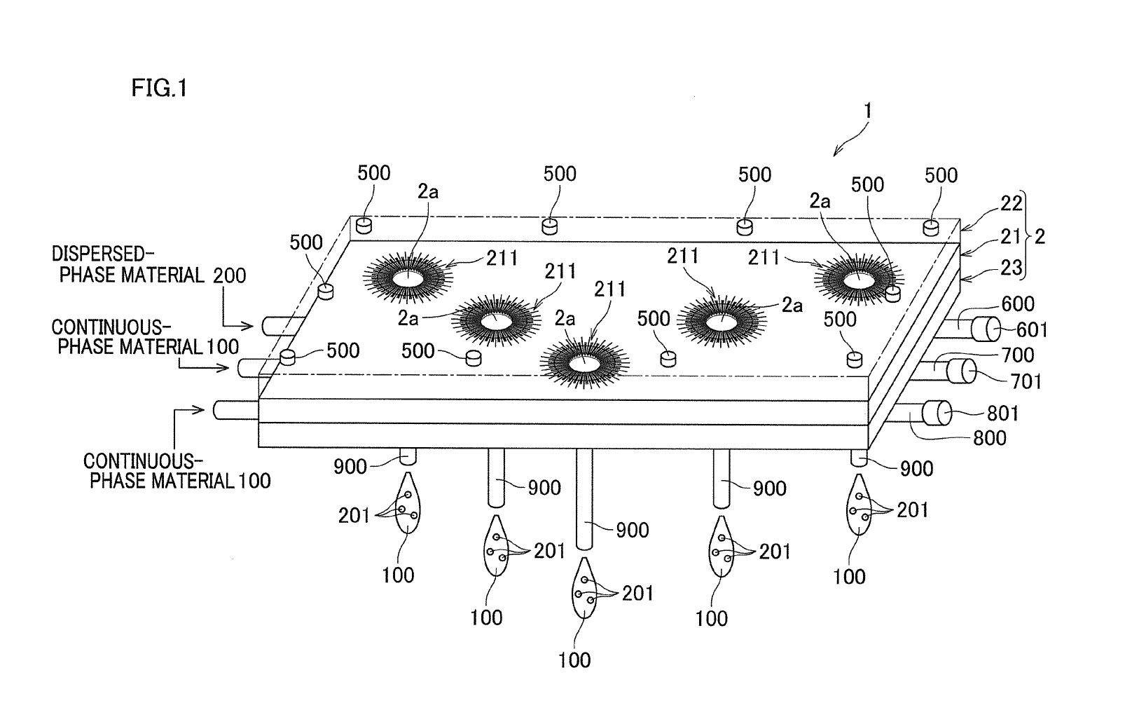

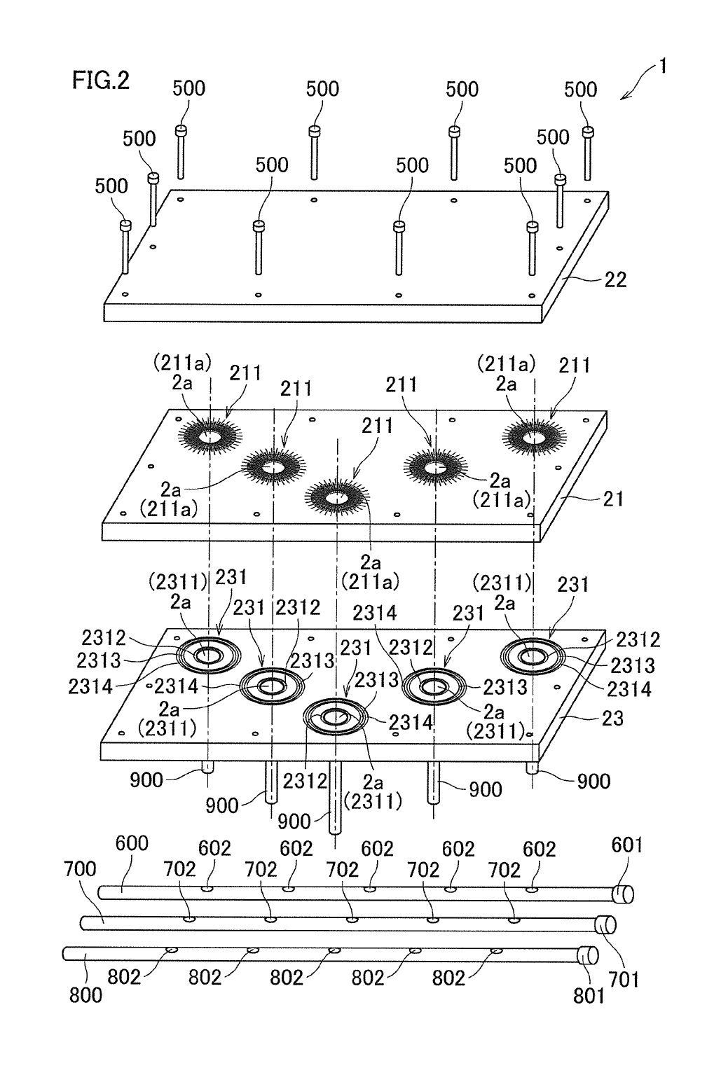

First, description will be given for an overview of a droplet formation device of this embodiment, with reference to FIGS. 1 and 2. FIG. 1 is a perspective view of the droplet formation device of this embodiment. FIG. 2 is an exploded view of the droplet formation device of this embodiment.

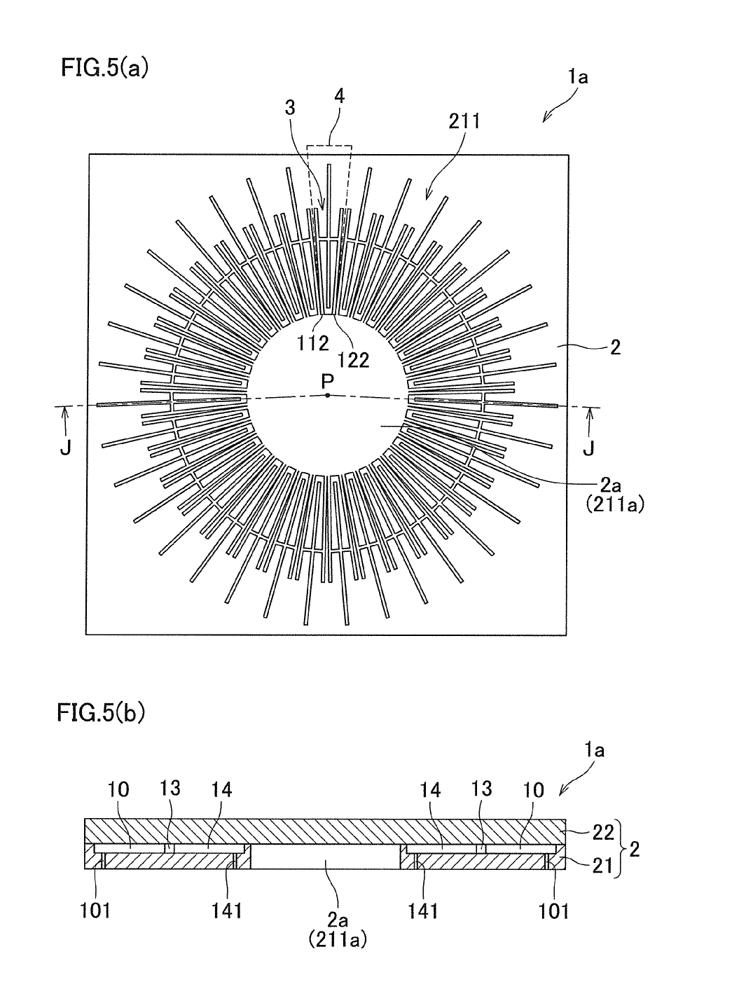

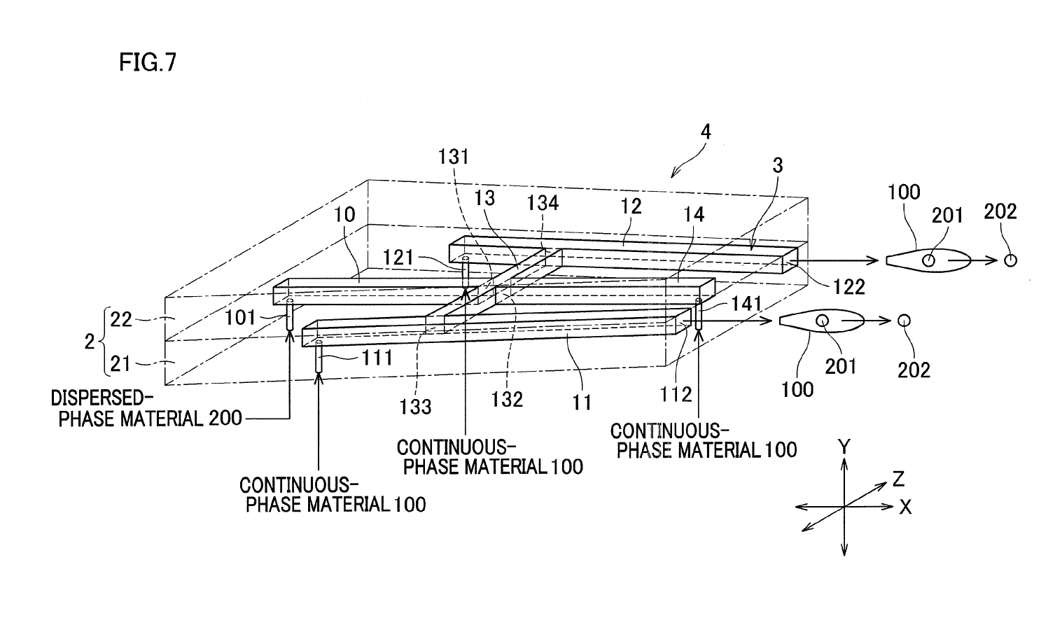

A droplet formation device 1 of this embodiment includes a base member 2 formed of a plurality of substrates (three substrates in this embodiment) stacked on one another, the substrates including a middle substrate 21 (an example of a first substrate of the present invention) and a lower substrate 23 (an example of a second substrate of the present invention). The droplet formation device 1 includes passage structures 211 formed on the middle substrate 21. Each of the passage structures 211 includes a plurality of droplet formation passages 3 (FIG. 5(a)) through which a liquid of a dispersed-phase material 200 and a liquid of a continuous-phase material 100 flow, to form droplets 201 of the dispersed-phase material 200 using a shear force of the continuous-phase material 100. The droplet formation device 1 further includes liquid storage parts 231 formed on the lower substrate 23. Each of the liquid storage parts 231 includes a dispersed-phase storage part 2314 which stores the liquid of the dispersed-phase material 200, and continuous-phase storage parts 2312 and 2313 which store the liquid of the continuous-phase material 100. The droplet formation device 1 further includes dispersed-phase material supply parts 101 (FIGS. 5(b) and 7) through each of which the dispersed-phase material 200 is supplied from the associated dispersed-phase storage part 2314 to the corresponding droplet formation passage 3 of the passage structure 211. Note that the number of the dispersed-phase material supply parts 101 formed corresponds to the number of the droplet formation passages 3. The droplet formation device 1 further includes continuous-phase material supply parts 111, 121, and 141 (FIG. 7) through each of which the continuous-phase material 100 is supplied from the associated continuous-phase storage part 2312, 2313 to the corresponding droplet formation passage 3 of the passage structure 211. Note that the number of the continuous-phase material supply parts 111, the number of the continuous-phase material supply parts 121, and the number of the continuous-phase material supply parts 141 correspond to the number of the droplet formation passages 3.

In the above structure, the dispersed-phase storage parts 2314 and the continuous-phase storage parts 2312 and 2313 are formed on the same single substrate (on the lower substrate 23). Meanwhile, the passage structures 211 are formed on the middle substrate 21. Thus, the main elements for forming the droplets 201 are formed on the two substrates which are the middle substrate 21 and the lower substrate 23, and this allows the droplet formation device 1 to have a smaller number of components, and to be easily disassembled and easily assembled.

Further, the dispersed-phase storage parts 2314 and the continuous-phase storage parts 2312 and 2313 are formed in the base member 2. Therefore, the manner of providing the dispersed-phase material supply parts 101 and the manner of providing the continuous-phase material supply parts 111, 121, and 141 are simplified, compared with the conventional art where: elements corresponding to these storage parts are provided outside the base member; and the continuous-phase material supply part for supplying the continuous-phase material from the continuous-phase storage part to each droplet formation passage of the passage structures and the dispersed-phase material supply part for supplying the dispersed-phase material from the dispersed-phase storage part to each droplet formation passage of the passage structures are provided so as to pass the respective through holes in the base member. This also allows the droplet formation device 1 to be disassembled easily and assembled easily.

(Detailed Description of Droplet Formation Device)

The following describes the droplet formation device 1 structured as above, in more detail.

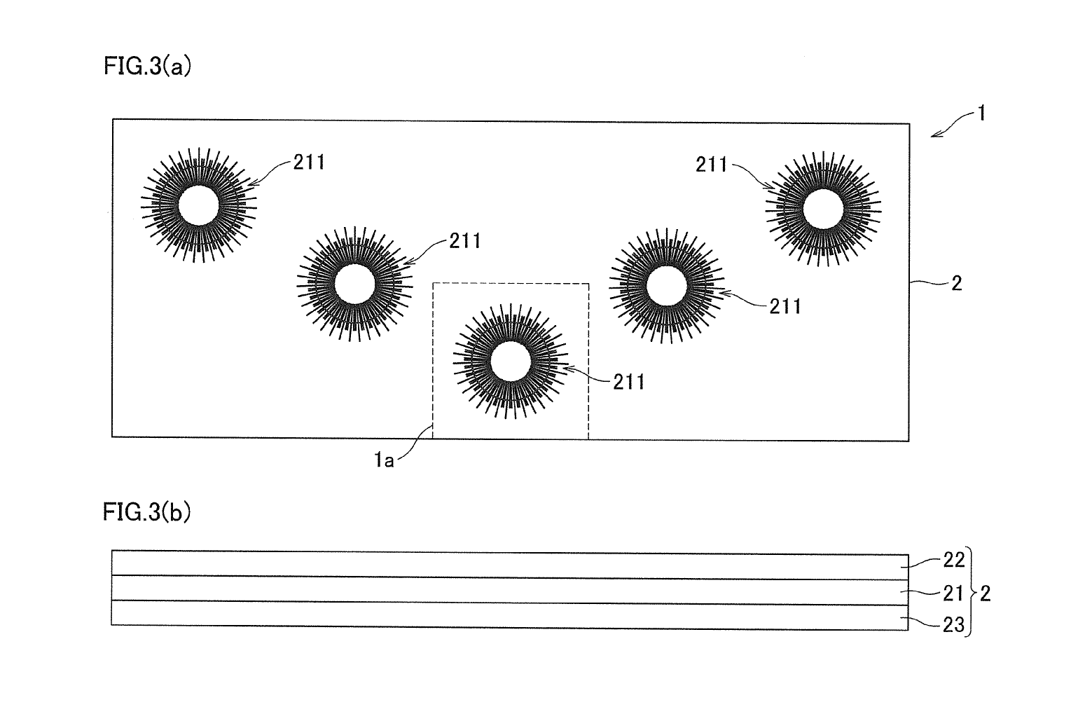

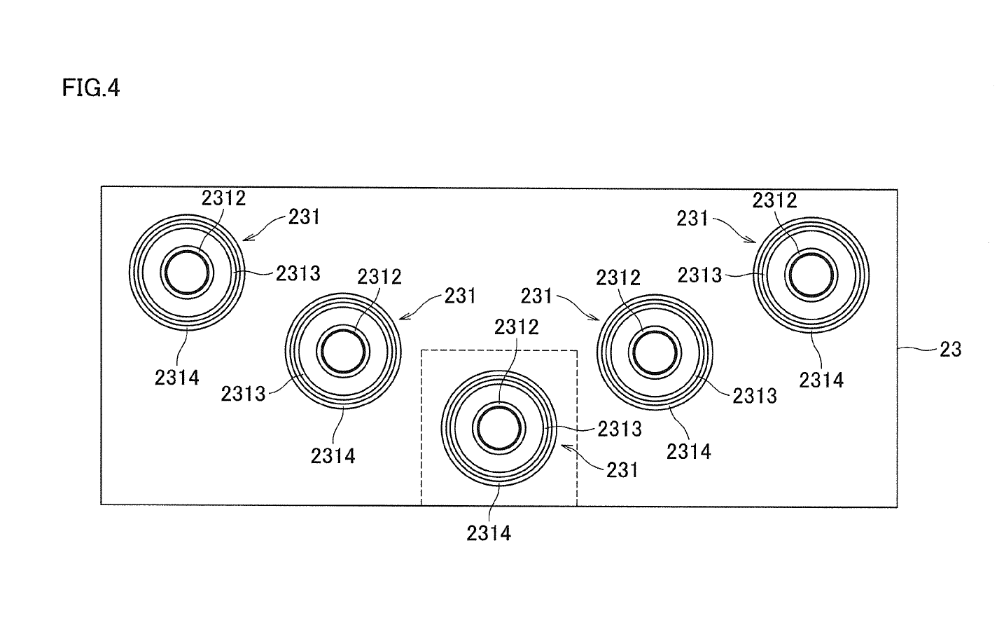

First, description will be given referring to FIGS. 1 to 4. FIG. 3(a) is a plan view of the droplet formation device of this embodiment, and FIG. 3(b) is a side view of the droplet formation device of this embodiment, viewed from the front. FIG. 4 is a plan view of the lower substrate. The droplet formation device 1 includes a base member 2 formed of the lower substrate 23, the middle substrate 21, and an upper substrate 22 which are stacked on one another in this order from bottom to top. The middle substrate 21, the upper substrate 22, and the lower substrate 23 are plate-like rectangular parallelepiped members, and the stacked substrates are secured to each other in a disassemblable manner. In this embodiment, the substrates 21, 22, and 23 are bolted to each other using a fixing member 500 such as a bolt to be secured in the disassemblable manner; however, the substrates may be secured in any other way as long as they are secured in a disassemblable manner.

On a surface of the middle substrate 21, there are formed the plurality of (e.g., five) passage structures 211 through which the liquid of the continuous-phase material 100 and the liquid of the dispersed-phase material 200 flow to form the droplets 201 of the dispersed-phase material 200 using the shear force of the continuous-phase material 100. The passage structures 211 are formed on the same horizontal plane. The five passage structures 211 are spaced apart from one another with a predetermined distance therebetween. The detailed structure of each passage structure 211 will be described later. The upper substrate 22 is a member made of a resin and functioning as a lid for the middle substrate 21, and the elasticity of the resin ensures the sealing between the upper substrate 22 and the middle substrate 21. Further, since the upper substrate 22 is transparent, the upper surface of the middle substrate 21 is visible through the upper substrate 22 when the droplet formation device 1 is viewed from above, as shown in FIG. 3(a).

On a surface of the lower substrate 23, there are formed the plurality of liquid storage parts 231 which store the dispersed-phase material 200 and the continuous-phase material 100 to be supplied to the five passage structures 211. Note that, the number of the liquid storage parts 231 corresponds to the number of the passage structures 211 (e.g., five liquid storage parts 231 are formed) in this embodiment; however, the number of the liquid storage parts 231 does not have to be the same as the number of the passage structures 211. For example, a single liquid storage part 231 may be shared by two or more passage structures 211. Each liquid storage part 231 includes: two continuous-phase storage parts 2312 and 2313 each of which stores the continuous-phase material 100; and one dispersed-phase storage part 2314 which stores the dispersed-phase material 200. The detailed structure of each liquid storage part 231 will be described later.

In the portion of the middle substrate 21 that is located above each liquid storage part 231, there are formed the continuous-phase material supply parts 111, 121, and 141 (FIG. 7) for supplying the continuous-phase material 100 stored in the continuous-phase storage parts 2312 and 2313 to the corresponding passage structure 211. Specifically, each of the continuous-phase material supply parts 111, 121, and 141 is a through hole formed in a height direction in the middle substrate 21, and the upper end of each through hole communicates with the passage structure 211. With this, the continuous-phase material 100 stored in the continuous-phase storage parts 2312 and 2313 is supplied to the passage structure 211 through the continuous-phase material supply parts 111, 121, and 141 which are the through holes. Meanwhile, in the portion of the middle substrate 21 that is located above each liquid storage part 231, there are formed the dispersed-phase material supply parts 101 (FIG. 7) for supplying the dispersed-phase material 200 stored in the dispersed-phase storage part 2314 to the corresponding passage structure 211. Specifically, each dispersed-phase material supply part 101 is a through hole formed in the height direction in the middle substrate 21, and the upper end of the through hole communicates with the passage structure 211. With this, the dispersed-phase material 200 stored in the dispersed-phase storage part 2314 is supplied to the passage structure 211 through the dispersed-phase material supply parts 101 which are the through holes. The detailed structure of each continuous-phase material supply part 111, 121, 141, and the detailed structure of each dispersed-phase material supply part 101 will be described later.

As described above, main elements for forming the droplets 201 are formed in/on the two substrates which are the middle substrate 21 and the lower substrate 23 in this embodiment, and therefore, the droplet formation device 1 has the smaller number of components, and is disassembled easily and assembled easily. Further, since the liquid storage parts 231 are formed in the base member 2, the structure of the dispersed-phase material supply parts 101 and the structure of the continuous-phase material supply parts 111, 121, and 141 are simpler than those in the conventional art where the liquid storage parts 231 are provided outside the base member.

The droplet formation device 1 is provided with discharge paths 2a through which the droplets 201 of the dispersed-phase material 200 formed through the passage structure 211 are discharged to the outside of the base member 2 so that one discharge path 2a is formed for each passage structure 211. Each of the discharge paths 2a is formed in the base member 2, and is a through hole having a circular shape in a plan view. Each discharge path 2a includes a first discharge path 211a which is a through hole formed in the height direction in the middle substrate 21, and a second discharge path 2311 formed in the height direction in the lower substrate 23. Note that the first discharge path 211a and the second discharge path 2311 are formed so as to be contiguous with each other. The droplets 201 are discharged from the passage structure 211 to the first discharge path 211a, and the thus discharged droplets 201 pass through the first discharge path 211a and the second discharge path 2311 and then discharged to the outside of the base member 2.

A lower opening of each second discharge path 2311 is coupled to a collection pipe 900, and the droplets 201 discharged from the second discharge path 2311 are forwarded to the next process via the collection pipe 900. The discharged droplets 201 become small particles 202 to be used in embolization, drug delivery systems, or the like, after predetermined processes are performed. The details of the predetermined processes will be described later.

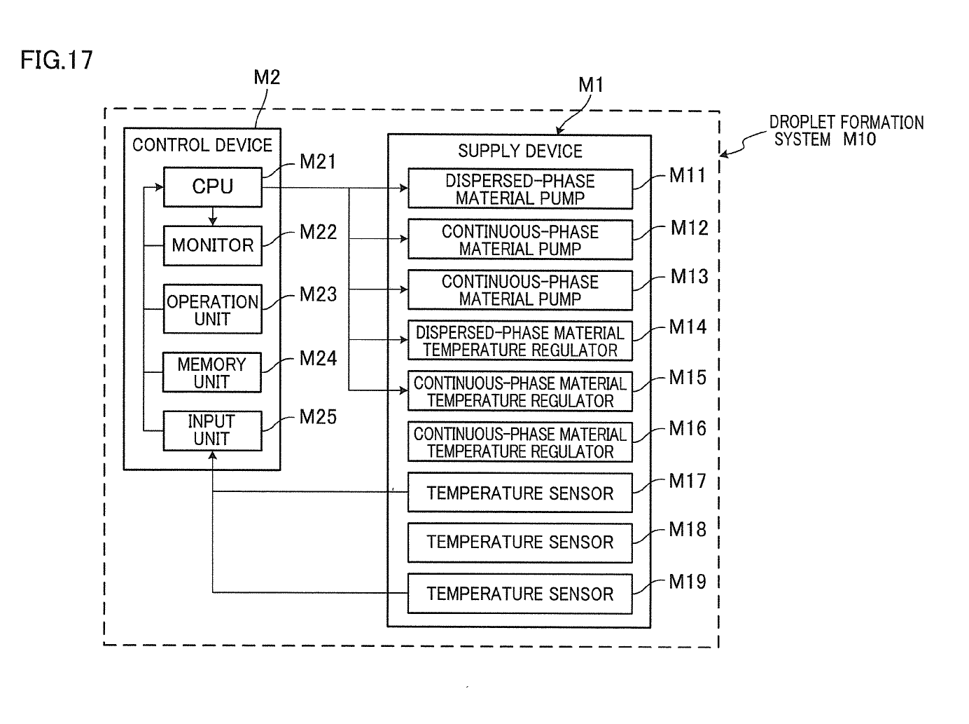

The droplet formation device 1 includes a supply member 601 for supplying the dispersed-phase material 200 from a not-shown storage tank for the dispersed-phase material 200 provided outside the base member 2 to the dispersed-phase storage parts 2314. The supply member 601 is a pipe having a closed end, and the supply member 601 includes holes 602 formed at positions corresponding to the dispersed-phase storage parts 2314. The other end of the supply member 601 is coupled with a supply device M1 (FIG. 17) including the not-shown storage tank for the dispersed-phase material 200. Via the other end, the dispersed-phase material 200 flows from the not-shown storage tank into the supply member 601. The dispersed-phase material 200 having flowed in is supplied to the dispersed-phase storage parts 2314 via supply pipes (not shown) respectively attached to the holes 602. Note that the supply device M1 (FIG. 17) includes temperature controllers and flow volume controllers (such as pumps), and the supply device M1 is configured to supply the dispersed-phase material 200 to the dispersed-phase material supply parts 101 at a desired temperature, flow volume, and flow velocity.

The droplet formation device 1 includes a supply member 701 for supplying the continuous-phase material 100 from a not-shown storage tank for the continuous-phase material 100 provided outside the base member 2 to the continuous-phase storage parts 2312. The droplet formation device 1 further includes a supply member 801 for supplying the continuous-phase material 100 from another not-shown storage tank for the continuous-phase material 100 provided outside the base member 2 to the continuous-phase storage parts 2313. Each supply member 701, 801 is a pipe having a closed end, and includes holes 702, 802 formed at positions corresponding to the continuous-phase storage parts 2312, 2313. The other end of each supply member 701, 801 is coupled with the supply device M1 (FIG. 17) including the not-shown storage tanks for the continuous-phase material 100, and via the other ends, the continuous-phase material 100 flows in from the not-shown storage tanks. Note that the supply device M1 includes the not-shown storage tank for the supply member 801, separately from to the not-shown storage tank for the supply member 701. The continuous-phase material 100 having flowed into the supply member 701, 801 is supplied to the continuous-phase storage parts 2312, 2313 via not-shown supply pipes respectively attached to the holes 702, 802.

(Droplet Formation Module 1a)

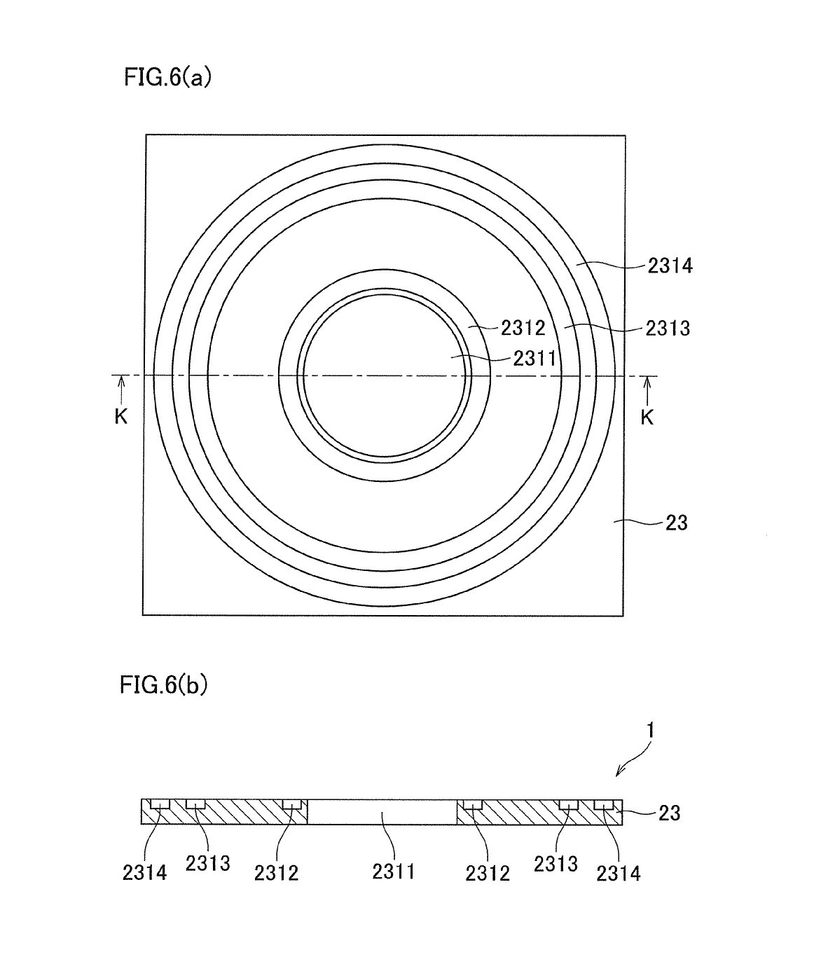

The above-described droplet formation device 1 includes five droplet formation modules la each having one passage structure 211 and one liquid storage part 231 as shown in FIG. 3(a). Hereinafter, the structure of each droplet formation module 1a will be described with reference to FIGS. 5 and 6. FIG. 5(a) is a plan view of a droplet formation module of this embodiment, and FIG. 5(b) is a sectional view of the droplet formation module taken along a line J-J in FIG. 5(a). FIG. 6 is a plan view of the lower substrate (a portion of the lower substrate that is enclosed with a dotted line in FIG. 4) of the droplet formation module.

(Droplet Formation Module 1a: Passage Structure 211)

First, the passage structure 211 will be described with reference to FIGS. 5(a) and 5(b). Each droplet formation module 1a includes a plurality of (e.g., seventy) liquid formation units 4 each having one droplet formation passage (in this embodiment, one droplet formation passage 3 is constituted by one dispersed-phase passage 10, one communication passage 13, and three continuous-phase passages 11, 12, and 14). In other words, in each droplet formation module 1a, one passage structure 211 having the plurality of (e.g., seventy) droplet formation passages 3 is formed on the upper surface of the middle substrate 21. As described above, since the upper substrate 22 is transparent, the passage structure 211 formed on the middle substrate 21 is visible through the upper substrate 22 as shown in FIG. 5(a), when viewing the droplet formation module 1a from above.

The passage structure 211 is formed of a group of the droplet formation passages 3. Specifically, in the passage structure 211, the droplet formation passages 3 are arranged radially in a circular line having a diameter of 50 mm, for example, and thereby the passages 3 are arranged annularly. In the passage structure 211, the droplet formation passages 3 are arranged at equal intervals; however, the passages 3 do not have to be arranged at equal intervals.

Each droplet formation passage 3 is arranged so that the flow in the passage is directed toward the center (a point P) of the portion where the passages 3 are annularly arranged. In other words, the droplet formation passages 3 are arranged in the annular portion having the point P as the center. Note that the point P and the passage structure 211 are on the same horizontal plane. At a downstream end of each droplet formation passage 3, discharge ports 112 and 122 are formed so as to face the point P, and the droplets 201 formed through the droplet formation passage 3 are discharged from the discharge ports 112 and 122. Thus, the droplet formation passages 3 are arranged so that all the discharge ports 112 and 122 face the point P, and therefore, the discharge ports 112 and 122 are located close to one another in a region around the point P. With this, in proportion as the discharge ports 112 and 122 are closely located, the space for the group of the droplet formation passages 3 is saved.

Further, a single first discharge path 211a for discharging the droplets 201 to the outside is formed at a position corresponding to the point P on the middle substrate 21, that is, at the center of the annular portion. To be more specific, the first discharge path 211a is a through hole penetrating the middle substrate 21. The discharge ports 112 and 122 of the passage structure 211 communicate with the first discharge path 211a, and this allows the droplets 201 formed through the droplet formation passages 3 to be discharged to the first discharge path 211a. Thus, the single first discharge path 211a is shared by the plurality of discharge ports 112 and 122. That is, the plurality of discharge ports 112 and 122 do not have their respective discharge paths, and this saves the space for the structure for discharging droplets. Further, since the first discharge path 211a is formed at the position corresponding to the point P, it is easy to cause the discharge ports 112 and 122 to directly communicate with the first discharge path 211a. This further saves the space for the structure for discharging the droplets 201.

(Droplet Formation Module 1a: Liquid Storage Part 231)

The following describes the structure of each liquid storage part 231 with reference to FIGS. 4 and 6. As described above, each liquid storage part 231 is constituted by the continuous-phase storage parts 2312 and 2313 which store the continuous-phase material 100, and the dispersed-phase storage part 2314 which stores the dispersed-phase material 200. The continuous-phase storage parts 2312 and 2313, and the dispersed-phase storage part 2314 are formed on the lower substrate 23 into substantially circular shapes in a plan view so as to correspond to the arrangement of the group of the droplet formation passages 3 (in other words, each storage part has a shape corresponding the annular arrangement). Specifically, the continuous-phase storage parts 2312 and 2313, and the dispersed-phase storage part 2314 are formed into disc shapes respectively, in a plan view, so as to form concentric circles having different diameters. Note that, the center of the concentric circles is in the substantially same location, in a plan view, as the center of the annularly-arranged droplet formation passage 3 (i.e., as the point P in FIG. 5(a)). This allows each liquid storage part 231 to be positioned immediately below the corresponding passage structure 211.

Among the continuous-phase storage parts 2312 and 2313 and the dispersed-phase storage part 2314, the storage part which has the smallest diameter and is formed innermost is the continuous-phase storage part 2312. The dispersed-phase storage part 2313 is formed farther from the center than the continuous-phase storage part 2312. Further, the dispersed-phase storage part 2314 is formed farther from the center than the continuous-phase storage part 2313. Before the upper substrate 22 is stacked on the middle substrate 21, an O-ring is placed in each of the following spaces: a space between the continuous-phase storage parts 2312 and 2313, a space between the continuous-phase storage part 2313 and the dispersed-phase storage part 2314, a space closer to the center than the continuous-phase storage part 2312, and the space farther from the center than the dispersed-phase storage part 2314. This ensures the sealing in the spaces between the continuous-phase storage parts 2312 and 2313, and between the continuous-phase storage part 2313 and the dispersed-phase storage part 2314, and efficiently prevents mixing of the continuous-phase material 100 with the dispersed-phase material 200.

Above the continuous-phase storage part 2312, through holes communicating with the passage structure 211 (communicating with the respective continuous-phase passages 14 in FIG. 5(b)) are formed in the middle substrate 21. These through holes are the continuous-phase material supply parts 141 (FIG. 5(b)), and allow the continuous-phase material 100 stored in the continuous-phase storage part 2312 to flow into the passage structure 211 (into the respective continuous-phase passages 14 in FIG. 5(b)). As described above, each passage structure 211 is constituted by the group of the droplet formation passages 3. The continuous-phase material supply parts 141 are respectively formed for the droplet formation passages 3 (for the continuous-phase passages 14). This allows the continuous-phase material 100 in the single continuous-phase storage part 2312 to be supplied to the group of the droplet formation passages 3 (to the continuous-phase passages 14).

Further, above the dispersed-phase storage part 2314, through holes communicating with the passage structure 211 (communicating with the respective dispersed-phase passages 10 in FIG. 5(b)) are formed in the middle substrate 21. These through holes are the dispersed-phase material supply parts 101 (FIG. 5(b)), which allow the dispersed-phase material 200 stored in the dispersed-phase storage part 2314 to flow into the passage structure 211 (into the dispersed-phase passages 10 in FIG. 5(b)). Each passage structure 211 is constituted by the group of the droplet formation passages 3, and the dispersed-phase material supply parts 101 are respectively formed for the droplet formation passages 3 (for the dispersed-phase passages 10). This allows the dispersed-phase material 200 in the single dispersed-phase storage part 2314 to be supplied to the group of the droplet formation passages 3 (to the dispersed-phase passages 10).

Furthermore, above the continuous-phase storage part 2313, through holes communicating with the passage structure 211 (communicating with the continuous-phase passages 11 and 12 which will be described later with reference to FIG. 7) are formed in the middle substrate 21. These through holes are the continuous-phase material supply parts 111 and 121 (FIG. 7), which allow the continuous-phase material 100 stored in the continuous-phase storage part 2313 to flow into the passage structure 211 (into the continuous-phase passages 11 and 12 in FIG. 7). Each passage structure 211 is constituted by the group of the droplet formation passages 3, and the sets of the continuous-phase material supply parts 111 and 121 are respectively formed for the droplet formation passages 3 (the continuous-phase material supply parts 111 and 121 are respectively formed for the continuous-phase passages 11 and 12). This allows the continuous-phase material 100 in the single continuous-phase storage part 2313 to be supplied to the group of the droplet formation passages 3 (to the continuous-phase passages 11 and 12).

The second discharge path 2311 is formed at the center of each liquid storage part 231. The upper end of the second discharge path 2311 communicates with the lower end of the first discharge path 211a of the middle substrate 21. Further, the lower end of the second discharge path 2311 communicates with the collection pipe 900 (FIG. 1). With this, the droplets 201 discharged from the passage structure 211 is discharged to the second discharge path 2311 via the first discharge path 211a, and then the droplets 201 are discharged to the collection pipe 900 via the second discharge path 2311.

(Liquid Formation Unit)

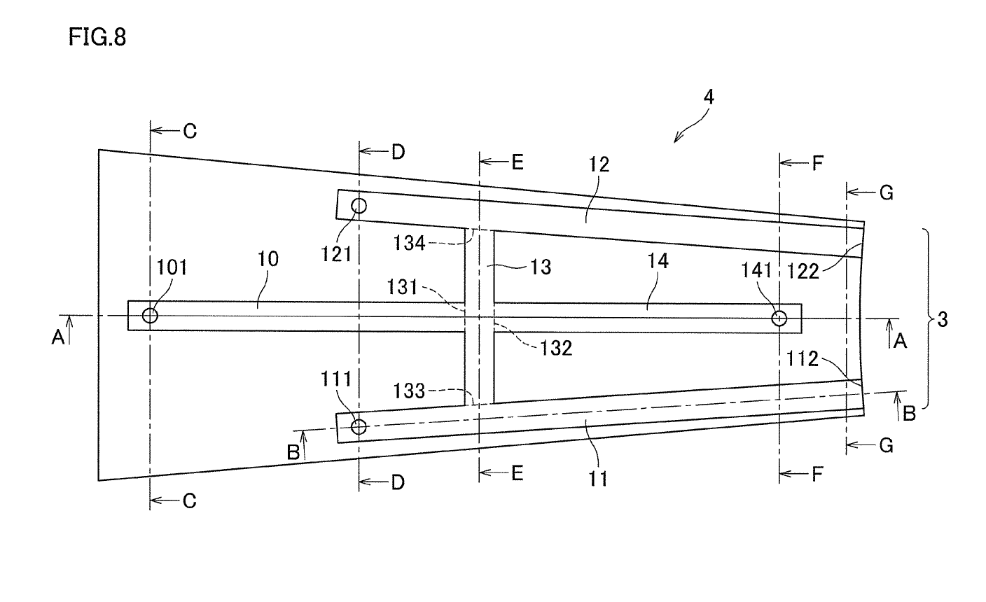

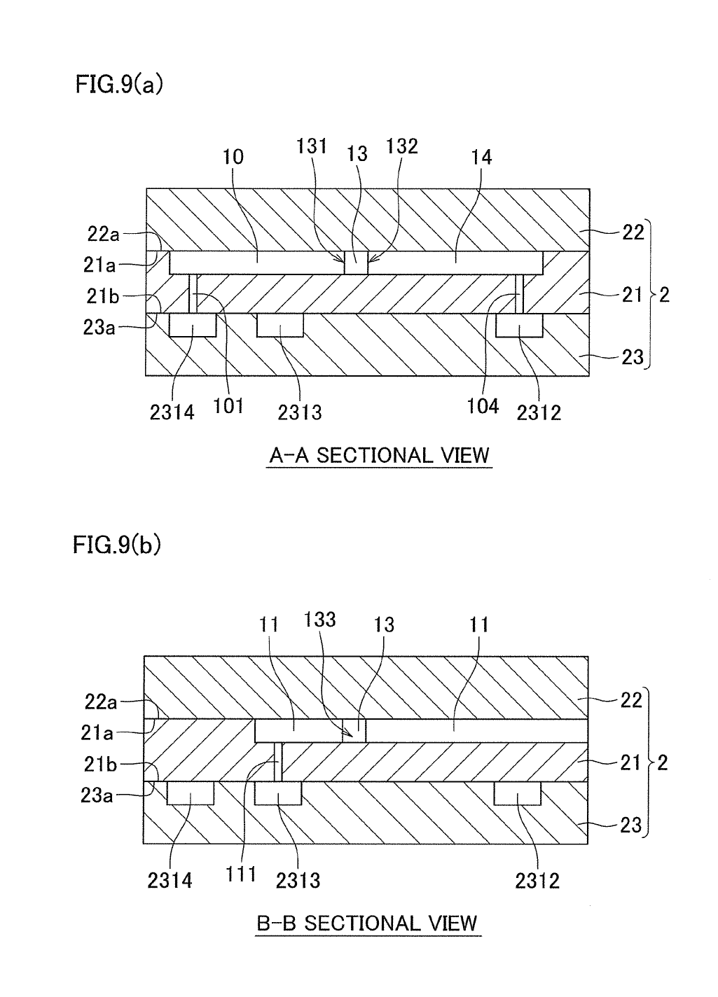

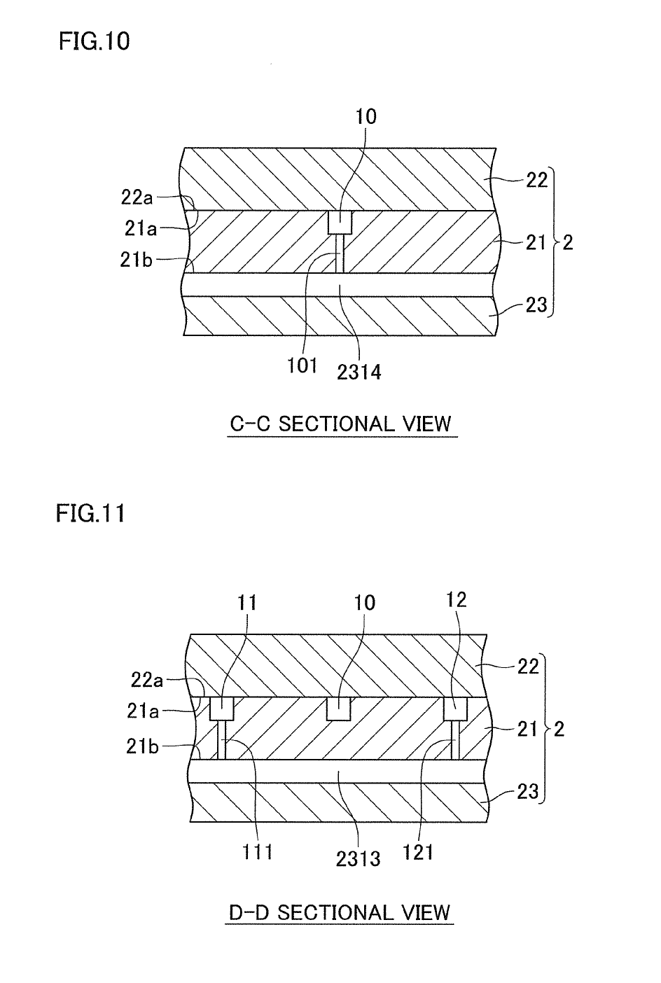

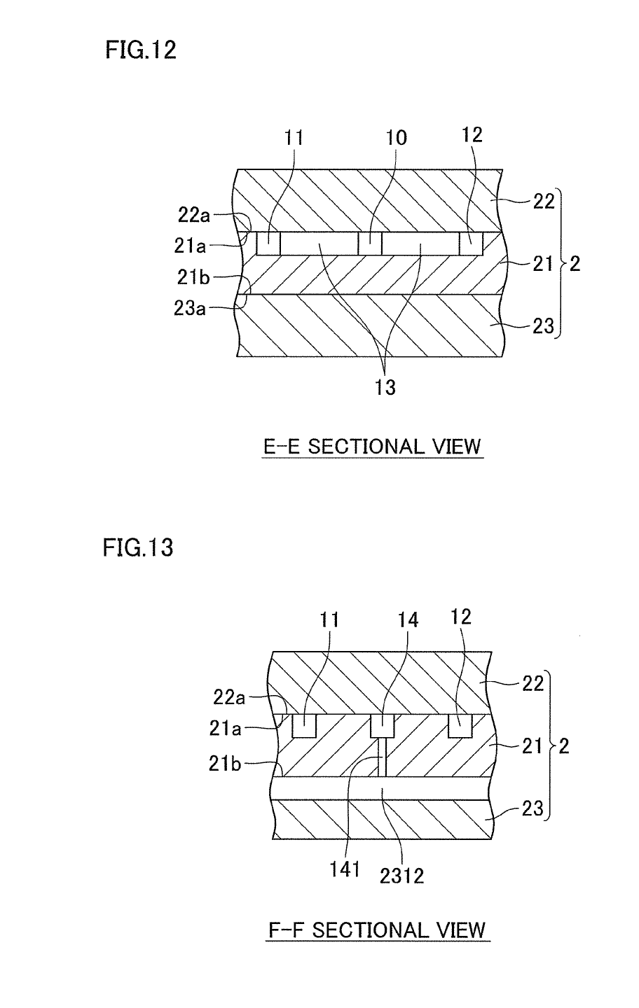

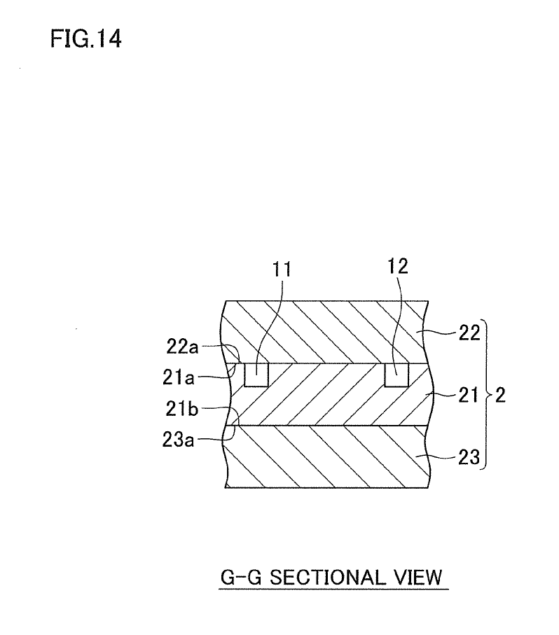

The following describes the structure of each of the liquid formation units 4 constituting each droplet formation module 1a, with reference to FIGS. 7 to 14. FIG. 7 is a perspective view of the liquid formation unit shown in FIG. 5(a). FIG. 8 is a plan view of the liquid formation unit, showing the schematic structure of the liquid formation unit. FIG. 9(a) is a sectional view of the liquid formation unit taken along a line A-A in FIG. 8, and FIG. 9(b) is a sectional view of the liquid formation unit taken along a line B-B in FIG. 8. FIG. 10 is a sectional view of the liquid formation unit taken along a line C-C in FIG. 8. FIG. 11 is a sectional view of the liquid formation unit taken along a line D-D in FIG. 8. FIG. 12 is a sectional view of the liquid formation unit taken along a line E-E in FIG. 8. FIG. 13 is a sectional view of the liquid formation unit taken along a line F-F in FIG. 8. FIG. 14 is a sectional view of the liquid formation unit taken along a line G-G in FIG. 8.

First, the structure of each liquid formation unit 4 will be described with reference to FIG. 7. Note that, in the following description, X direction in FIG. 7 is referred to as a “width direction” of the liquid formation unit 4, Z direction is referred to as a “depth direction” of the liquid formation unit 4, and Y direction is referred to as a “height direction” of the liquid formation unit 4.

The liquid formation unit 4 is configured so that: a flow of the dispersed-phase material 200 is branched into a plurality of flows; in each branch flow, the direction in which the continuous-phase material 100 flows crosses the direction in which the dispersed-phase material 200 flows; and using a shear force of the thus crossing continuous-phase material 100, the droplets 201 of the dispersed-phase material 200 are formed.

That is, the liquid formation unit 4 includes: the continuous-phase passages 11 and 12 through which the liquid of the continuous-phase material 100 flows; the single dispersed-phase passage 10 through which the liquid of the dispersed-phase material 200 flows; and the communication passage 13 which is configured to allow the dispersed-phase passage 10 to communicate with the continuous-phase passages 11 and 12 via communication openings 133 and 134, respectively, to form the droplets 201 of the dispersed-phase material 200 by using the shear force of the continuous-phase material 100 at the communication openings 133 and 134.

With the above structure, the communication passage 13 allows the dispersed-phase material 200 to flow into the continuous-phase passages 11 and 12 from the single dispersed-phase passage 10 via the communication openings 133 and 134. The continuous-phase material 100 flows through each of the continuous-phase passages 11 and 12, and the dispersed-phase material 200 flowing into the continuous-phase passages 11 and 12 via the communication openings 133 and 134 is formed into the droplets 201 by means of the shear force of the continuous-phase material 100, and thus, the droplets 201 of the dispersed-phase material 200 are formed in the continuous-phase passages 11 and 12. As described above, the dispersed-phase material 200 is supplied from the single dispersed-phase passage 10 to the plurality of continuous-phase passages 11 and 12 to form the droplets 201 of the dispersed-phase material 200. In the above structure, the single dispersed-phase passage 10 is shared by the plurality of continuous-phase passages 11 and 12. Therefore, compared with the conventional structure where the dispersed-phase material 200 is supplied to a plurality of continuous-phase passages 11 and 12 from the dispersed-phase passages 10 whose number is the same as that of the continuous-phase passages, the number of the dispersed-phase passages 10 is smaller while maintaining the number of droplets 201 formed. As a result, in proportion as the space for the dispersed-phase passages 10 is saved, it is possible to increase the number of the continuous-phase passages 11 and 12 arranged in one passage structure 211, leading to an increase in productivity per unit time in forming the droplets 201 of the dispersed-phase material 200.

Further, each droplet formation passage 3 includes the continuous-phase passage 14 through which the continuous-phase material 100 flows. The communication passage 13 communicates with the continuous-phase passage 14 in such a manner that, at the communication openings 133 and 134, the continuous-phase material 100 from the continuous-phase passage 14 flows downstream with respect to the direction in which the continuous-phase material 100 flows through the continuous-phase passages 11 and 12. To be more specific, one end of the continuous-phase passage 14 communicates with the communication passage 13. The portion of the communication passage 13 that communicates with the continuous-phase passage 14 is opposed to the portion of the communication passage 13 that communicates with the dispersed-phase passage 10.

Because of this, in the communication passage 13, the continuous-phase material 100 flowing from the continuous-phase passage 14 collides with the dispersed-phase material 200 flowing from the dispersed-phase passage 10. This collision branches the flows of the dispersed-phase material 200 and the continuous-phase material 100 at the position of the collision in the communication passage 13, so that each flow heads to both of the continuous-phase passage 11 and the continuous-phase passage 12. After the collision of the dispersed-phase material 200 with the continuous-phase material 100, the dispersed-phase material 200 and the continuous-phase material 100 flow, in the form of two layers, from the communication passage 13 into the continuous-phase passages 11 and 12 via the communication openings 133 and 134, respectively. At each communication opening 133, 134, the dispersed-phase material 200 and the continuous-phase material 100 in the two-layer form flow in such a manner that the continuous-phase material 100 flows through the downstream portion of each communication opening (downstream with respect to the direction of the flow in the continuous-phase passage 11, 12). Therefore, even if the continuous-phase material 100 flowing through the continuous-phase passages 11 and 12 presses the two-layered dispersed-phase material 200 and continuous-phase material 100 onto the communication openings 133 and 134, the continuous-phase material 100 in the two-layer form effectively prevents the dispersed-phase material 200 from being attached to the communication openings 133 and 134.

The following describes the passages constituting the droplet formation passage 3 of each liquid formation unit 4 individually, with reference to FIGS. 7 to 14.

(Liquid Formation Unit 4: Dispersed-Phase Passage 10)

The dispersed-phase passage 10 is formed as a space of an elongated substantially rectangular parallelepiped shape having a substantially square vertical section (e.g., substantially square section whose width and height are 0.5 mm). The dispersed-phase passage 10 is formed so as to extend from a position closer to one end of the middle substrate 21 of the liquid formation unit (one end in the width direction, that is, the left end in FIG. 7) toward the center of the middle substrate 21. Further, the dispersed-phase material supply part 101 is opened, at one end (at the left end in FIG. 7) of the dispersed-phase passage 10, onto the bottom surface of the dispersed-phase passage 10. As shown in FIG. 10, the dispersed-phase material supply part 101 is a tubular through hole formed in the middle substrate 21. The lower end (opening) of the dispersed-phase material supply part 101 communicates with the dispersed-phase storage part 2314. This allows the dispersed-phase material 200 stored in the dispersed-phase storage part 2314 to be supplied to the dispersed-phase passage 10 via the dispersed-phase material supply part 101.

The dispersed-phase passage 10 communicates with the communication passage 13 via a communication opening 131 at the other end, that is, at a side portion of the dispersed-phase passage 10 with respect to the width direction. This structure of the dispersed-phase passage 10 allows the dispersed-phase material 200 supplied through the dispersed-phase material supply part 101 to flow into the communication passage 13 via the communication opening 131.

(Liquid Formation Unit 4: Communication Passage 13)

The communication passage 13 is formed as a space of a substantially rectangular parallelepiped shape having a substantially square section (e.g., substantially square section whose width and height are 0.5 mm). The communication passage 13 is formed so as to extend in the depth direction in a portion of the middle substrate 21 of the liquid formation unit that portion is middle in the width direction. The communication passage 13 communicates with the dispersed-phase passage 10 via the communication opening 131, as described above, at a portion of a side surface of the communication passage 13 with respect to the width direction (at a portion of the left side surface in FIG. 7). Note that the communication opening 131 is formed in the portion of the above side surface that is middle in the depth direction. The communication passage 13 is further provided with a communication opening 132 formed so as to be opposed to the communication opening 131, and the communication passage 13 communicates with the continuous-phase passage 14 via the communication opening 132. This allows the continuous-phase material 100 to flow into the communication passage 13 from the continuous-phase passage 14 via the communication opening 132.

As described above, the communication opening 131 and the communication opening 132 are formed in the communication passage 13 so as to be opposed to each other, and because of this structure, in a space (collision space) between the communication opening 131 and the communication opening 132, the dispersed-phase material 200 entering through the communication opening 131 collides with the continuous-phase material 100 entering through the communication opening 132. In the communication passage 13, the above collision causes the flows of the dispersed-phase material 200 and the continuous-phase material 100 to be branched in the collision space and to flow toward the both ends of the communication passage 13 in the two-layer form.

Further, the communication passage 13 is provided with, at a side portion thereof with respect to the depth direction (at a side portion closer to a viewer in FIG. 7), a communication opening 133 formed for communication with the continuous-phase passage 11. Via the communication opening 133, the two-layered dispersed-phase material 200 and continuous-phase material 100 flow into the continuous-phase passage 11 from the communication passage 13. Meanwhile, the communication passage 13 is provided with, at the side portion opposite to the above side portion (at the side portion farther from the viewer in FIG. 7), a communication opening 134 for communication with the continuous-phase passage 12. Via the communication opening 134, the two-layered dispersed-phase material 200 and continuous-phase material 100 flow into the continuous-phase passage 12 from the communication passage 13.

(Liquid Formation Unit 4: Continuous-Phase Passage 14)

The continuous-phase passage 14 is formed as a space of elongated substantially rectangular parallelepiped shape having a substantially square section (e.g., substantially square section whose width and height are 0.5 mm). As shown in FIG. 9(a), the continuous-phase passage 14 is formed downstream of the dispersed-phase passage 10 so as to be adjacent to the dispersed-phase passage 10 with the communication passage 13 interposed therebetween. Further, the continuous-phase passage 14 is formed so as to extend collinearly with the dispersed-phase passage 10. As described above, the continuous-phase passage 14 communicates, at its one end closer to the dispersed-phase passage 10, with the communication passage 13 via the communication opening 132. Furthermore, at the other end of the continuous-phase passage 14, the continuous-phase material supply part 141 is opened onto the bottom surface of the continuous-phase passage 14.

As shown in FIG. 13, the continuous-phase material supply part 141 is a tubular through hole formed in the middle substrate 21. The lower end (opening) of the continuous-phase material supply part 141 communicates with the continuous-phase storage part 2312. This allows the continuous-phase material 100 stored in the continuous-phase storage part 2312 to be supplied to the continuous-phase passage 14 via the continuous-phase material supply part 141. Thus, the continuous-phase passage 14 is configured so that the continuous-phase material 100 supplied through the continuous-phase material supply part 141 flows toward the communication opening 132, and flows into the communication passage 13 via the communication opening 132.

(Liquid Formation Unit 4: Continuous-Phase Passages 11 and 12)

Each continuous-phase passage 11, 12 is formed on the upper surface of the middle substrate 21 as a space having a substantially square section (e.g., substantially square section whose width and height are 0.5 mm). Each continuous-phase passage 11, 12 is formed so as to extend from a position closer to the one end of the middle substrate 21 of the liquid formation unit (one end in the width direction, that is, the left end in FIG. 7) toward the other end. Assuming that the liquid formation unit 4 is placed so that the dispersed-phase passage 10 is at the left and the continuous-phase passage 14 is at the right (that is, the liquid formation unit 4 is placed as shown in FIG. 7), the continuous-phase passage 12 is located farther from the viewer than the dispersed-phase passage 10, and the continuous-phase passage 11 is located closer to the viewer than the dispersed-phase passage 10.

Further, the continuous-phase material supply part 111 is opened, at one end (the left end in FIG. 7) of the continuous-phase passage 11, onto a bottom surface of the continuous-phase passage 11, and the continuous-phase material supply part 121 is opened, at one end (the left end in FIG. 7) of the continuous-phase passage 12, onto a bottom surface of the continuous-phase passage 12. As shown in FIG. 11, each continuous-phase material supply part 111, 121 is a tubular through hole formed in the middle substrate 21. The lower end (opening) of each continuous-phase material supply part 111, 121 communicates with the continuous-phase storage part 2313. This allows the continuous-phase material 100 stored in the continuous-phase storage part 2313 to be supplied to the continuous-phase passages 11 and 12 via the continuous-phase material supply parts 111 and 121, respectively.

At the other ends of the continuous-phase passages 11 and 12, the discharge ports 112 and 122 are respectively formed at side portions of the continuous-phase passages 11 and 12 with respect to the width direction, and the continuous-phase material 100 supplied from the continuous-phase material supply parts 111 and 121 flows toward the discharge ports 112 and 122 to be discharged through the discharge ports 112 and 122, respectively. Further, the continuous-phase passage 11 communicates with the communication passage 13 via the communication opening 133 at a portion of a side surface of the continuous-phase passage 11 which surface closer to the dispersed-phase passage 10 (a side surface farther from the viewer in FIG. 7), as described above. This allows the two-layered dispersed-phase material 200 and continuous-phase material 100 to flow into the continuous-phase passage 11 from the communication passage 13 via the communication opening 133, as described above.

The continuous-phase passage 12 also communicates with the communication passage 13 via the communication opening 134 at a portion of a side surface of the continuous-phase passage 12 which surface is closer to the dispersed-phase passage 10 (a side surface closer to the viewer in FIG. 7), as described above. This allows the two-layered dispersed-phase material 200 and continuous-phase material 100 to flow into the continuous-phase passage 12 from the communication passage 13 via the communication opening 134, as described above.

As described above, the continuous-phase passages 11 and 12 are configured so that the two-layered dispersed-phase material 200 and continuous-phase material 100 flow into the continuous-phase passages 11 and 12 from the communication passage 13 via the respective communication openings 133 and 134. Here, at the communication openings 133 and 134, the continuous-phase material 100 in the two-layer form flows through the downstream portion of each communication opening (downstream with respect to the direction of the flows in the continuous-phase passages 11 and 12). Therefore, subjected to the shear forces on both sides, which are the shear force of the continuous-phase material 100 flowing through the continuous-phase passage 11, 12 and the shear force of the continuous-phase material 100 in the two-layer form, the dispersed-phase material 200 is sheared, thereby formed into droplets. The thus formed droplets 201 of the dispersed-phase material 200 are discharged through the discharge ports 112 and 122 with the continuous-phase material 100. The discharge ports 112 and 122 communicate with the discharge path 2a (the first discharge path 211a), and the droplets 201 discharged through the discharge ports 112 and 122 pass through the discharge path 2a to be discharged to the collection pipe 900. The collection pipe 900 is coupled to a mechanism or a device used in a posterior step such as cooling, and the droplets 201 are collected by the mechanism or device.

In order to preferably form droplets of the dispersed-phase material 200, it is preferable to size the dispersed-phase passage 10, the continuous-phase passages 11, 12, and 14, and the communication passage 13 as follows. As shown in FIG. 8, it is preferable that, with respect to the depth direction of the liquid formation unit 4, the length of the portion of the communication passage 13 which portion extends from the communication opening 134 to the dispersed-phase passage 10 is substantially same as the length of the portion of the communication passage 13 which portion extends from the communication opening 133 to the dispersed-phase passage 10.

Further, as shown in FIGS. 9(a) and 9(b), it is preferable to form the passages so that the distance from the continuous-phase material supply part 111 to the communication opening 133 is equal to the distance from the continuous-phase material supply part 121 to the communication opening 134, with respect to the width direction of the liquid formation unit 4.

(Base Member 2)

The following describes the structure of the base member 2 of the droplet formation device 1, with reference to FIGS. 1 to 14.

As shown in FIGS. 1 and 2, the base member 2 is formed of the middle substrate 21, the upper substrate 22, and the lower substrate 23. Each of the middle substrate 21, the upper substrate 22, and the lower substrate 23 has an elongated substantially rectangular parallelepiped shape with a predetermined thickness. Note that, the five first discharge paths 211a are formed in the middle substrate 21, and the five second discharge paths 2311 are formed in the lower substrate 23.

Although the material for the base member 2 is not limited as long as the base member 2 is made of a material hardly wettable with respect to the dispersed-phase material 200, specifically, the middle substrate 21 and the lower substrate 23 are made of a resin such as polycarbonate, or of a metal such as stainless steel, glass, or the like, having a hydrophobically-treated surface. The upper substrate 22 may be made of the same material as that of the lower base member 21. In particular, the upper substrate 22 is preferably made of polycarbonate or an acrylic resin, or of a hydrophobically-treated glass or the like, and the upper substrate 22 is preferably transparent. The middle substrate 21 has a border surface 21a (where the passages are formed) on its top surface, and the upper substrate 22 has a border surface 22a on its under surface. The middle substrate 21 and the upper substrate 22 are formed into one piece by facing and combining the border surface 21a of the middle substrate 21a and the border surface 22a of the upper substrate 22 to and with each other. Further, the middle substrate 21 has a border surface 21b on its under surface, and the lower substrate 23 has a border surface 23a on its top surface. The middle substrate 21 and the lower substrate 23 are formed into one piece by facing and combining the border surface 21b of the middle substrate 21 and the border surface 23a of the lower substrate 23 to and with each other. In this way, the upper substrate 22, the middle substrate 21, and the lower substrate 23 are formed into one piece.

On the border surface 21a of the middle substrate 21, the five passage structures 211 are formed. In each passage structure 211, the plurality of droplet formation passages 3 are formed by grooves and the like so as to extend radially about the discharge path 2a. To be more specific, the dispersed-phase passages 10, the continuous-phase passages 11, 12, and 14, and the communication passages 13 are formed on the border surface 21a. Further, in the middle substrate 21, the continuous-phase material supply parts 111, 121, and 141, and the dispersed-phase material supply parts 101 are formed as through holes extending in the direction of the thickness of the middle substrate 21. Furthermore, in the middle substrate 21, the downstream ends of each pair of the continuous-phase passages 11 and 12 are opened to the associated discharge path 2a (the first discharge path 211a), and these open ends are the discharge ports 112 and 122.

On the border surface 23a of the lower substrate 23, the five liquid storage parts 231 are formed by grooves and the like at the respective positions corresponding to the five passage structures 211. To be more specific, the five continuous-phase storage parts 2312, the five continuous-phase storage parts 2313, and the five dispersed-phase storage parts 2314 are formed on the border surface 23a. Note that, each continuous-phase material supply part 141 is formed above the associated continuous-phase storage part 2312. Each continuous-phase material supply part 111, 121 is formed above the associated continuous-phase storage part 2313. Each dispersed-phase material supply part 101 is formed above the associated dispersed-phase storage part 2314.

(Dispersed-Phase Material 200)

The following describes the dispersed-phase material 200 and the continuous-phase material 100 used in the droplet formation device 1. The dispersed-phase material 200 is not particularly limited as long as it is a liquid functioning as dispersoid in an emulsion. For example, for the use of the small particles 202 in arterial embolization in treatment for liver cancer, uterine fibroids, kidney cancer, and the like, an aqueous gelatin solution is used as the dispersed-phase material 200. The type of gelatin in the aqueous gelatin solution is not particularly limited. For example, gelatin prepared using beef bones, beef skin, pork bones, pork skin, or the like is adoptable. Further, the dispersed-phase material 200 may be a liquid containing a medicinal substance. Small particles 202 made from the dispersed-phase material 200 containing a medicinal substance may be used, for example, in a drug delivery system or the like since these particles have a property of sustained release of the medicinal substance.

The temperature of the aqueous gelatin solution which is the liquid of the dispersed-phase material 200 needs to be equal to or higher than 20° C. which is the gelation temperature of the gelatin. This is because, temperatures of the aqueous gelatin solution equal to or lower than the gelation temperature of the gelatin cause gelation of the aqueous gelatin solution, which is possibly attached to the communication opening(s) 131, 133, and/or 134, and this is likely to cause a problem of clogging of the communication opening(s) 131, 133, and/or 134, which makes it impossible to output a constant amount of the aqueous gelatin solution. Further, this causes difficulties in separating the aqueous gelatin solution from the communication opening(s) 131, 133, and/or 134, consequently leading to variation in the diameter of the particles.

The concentration of the aqueous gelatin solution is preferably 2 wt. % to 20 wt. %, and more preferably 5 wt. % to 15 wt. %. The reason why the lower limit of the concentration is 2 wt. % is that the concentration of the solution less than 2 wt. % causes difficulties in forming spherical particles. Meanwhile, the reason why the upper limit of the concentration is 20 wt. % is that the concentration more than 20 wt. % causes the solution to be highly viscous, which makes it difficult for the solution to flow through the dispersed-phase passage 10 and the communication passage 13 and to flow out from the communication openings 131, 133, and 134, due to clogging or the like.

The shape of the gelatin particles from the state of droplets 201 to the state of the small particles 202 is preferably spherical, not an indeterminate form. Particularly, for the use of the small particles 202 as embolus particles, the spherical small particles 202 are able to block a blood vessel of a patient at a portion closer to a targeted part, while reducing the stress to the patient when injected into the blood vessel to block the blood vessel. The diameter of the small particles 202 suitably falls within any of the following three ranges: 40 to 100 μm; 150 to 300 μm; and 400 to 1000 μm. There are three suitable ranges for selective usage of the particles based on the sizes of the blood vessels to avoid negative effect to the healthy portions while blocking the blood vessel at the closest possible portion to the targeted part. Particles with small diameters of less than 40 μm are not preferable because such particles may block the blood vessel at a portion other than the intended portion.

(Continuous-Phase Material 100)

The continuous-phase material 100 is not particularly limited as long as it is a liquid functioning as a disperse medium in an emulsion. When the continuous-phase material 100 is a hydrophobic solvent used for forming the small particles 202 acting as embolus particles, any substances pharmaceutically allowable may be used as the continuous-phase material 100. For example, a vegetable oil such as olive oil, a fatty acid such as oleic acid, a fatty acid ester such as glyceryl tricaprylate, a hydrocarbon based solution such as hexane and the like are adoptable. Particularly, olive oil and glyceryl tricaprylate which is a hardly-oxidized medium-chain fatty acid ester are preferable.

(Process of Fabricating Droplet Formation Device 1)

The following describes a process of fabricating the droplet formation device 1 with reference to FIGS. 1 to 14. The middle substrate 21 having the five first discharge paths 211a, the lower substrate 23 having the five second discharge paths 2311, and the upper substrate 22 are prepared. On the border surface 21a of the middle substrate 21, the five passage structures 211 are formed. In each passage structure 211, grooves to function as the seventy droplet formation passages 3 are formed so that the grooves are arranged substantially annularly around the discharge path 2a acting as the center. To be more specific, in each droplet formation passage 3, grooves to function as the dispersed-phase passage 10, the continuous-phase passages 11, 12, and 14, and the communication passage 13 are formed by cutting, etching, laser machining, or the like. These passages are formed so that the discharge ports 112 and 122 of the continuous-phase passages 11 and 12 face the center of the circle (face the first discharge path 211a). Further, through holes functioning as the dispersed-phase material supply parts 101, the continuous-phase material supply parts 111, 121, and 141 are formed.

On the border surface 23a of the lower substrate 23, the five liquid storage parts 231 are formed by grooves and the like. Each liquid storage part 231 is formed around the corresponding second discharge path 2311. To be more specific, around each second discharge path 2311, one continuous-phase storage part 2312, one continuous-phase storage part 2313, and one dispersed-phase storage part 2314 are formed so that the continuous-phase storage part 2312 is located innermost, followed by the continuous-phase storage part 2313 and the dispersed-phase storage part 2314 in this order.

Then, the lower substrate 23, the middle substrate 21, and the upper substrate 22 are stacked on one another in this order. To be more specific, the border surface 21a and the border surface 22a are brought into close contact with each other. Further, after the O-rings are placed between the border surface 21b of the middle substrate 21 and the border surface 23a of the lower substrate 23, the border surface 21b and the border surface 23a are caused to face each other. After stacked in this manner, the lower substrate 23, the middle substrate 21, and the upper substrate 22 are bolted using the fixing member 500. Thus, the droplet formation device 1 is fabricated.

(Process of Forming Small Particles 202)

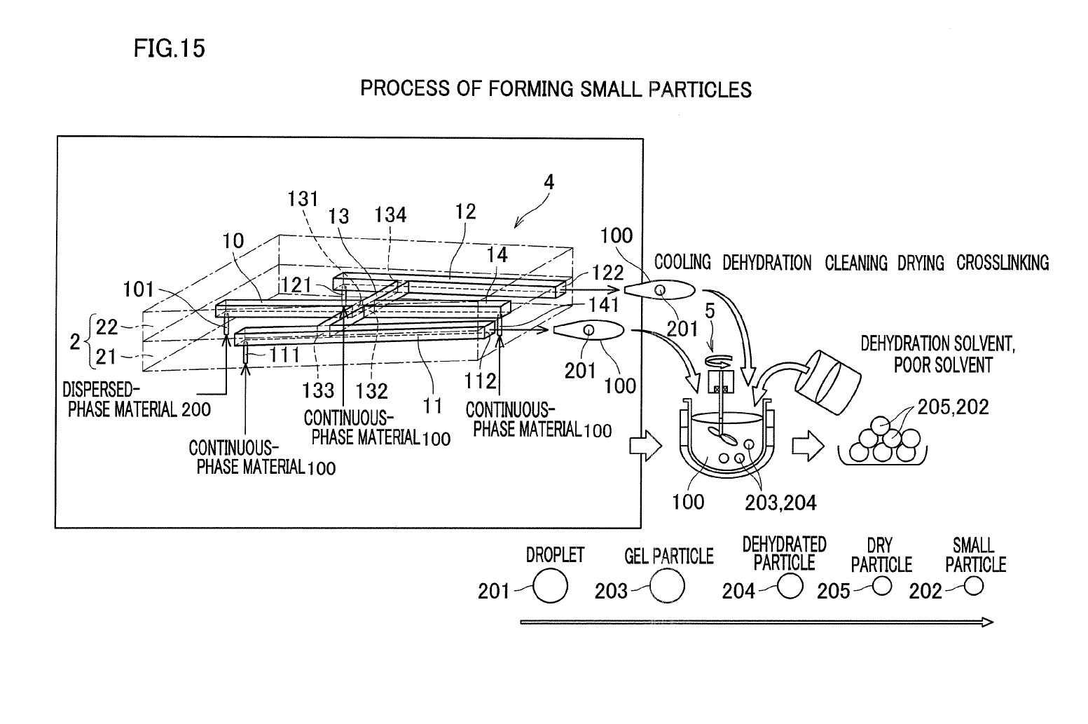

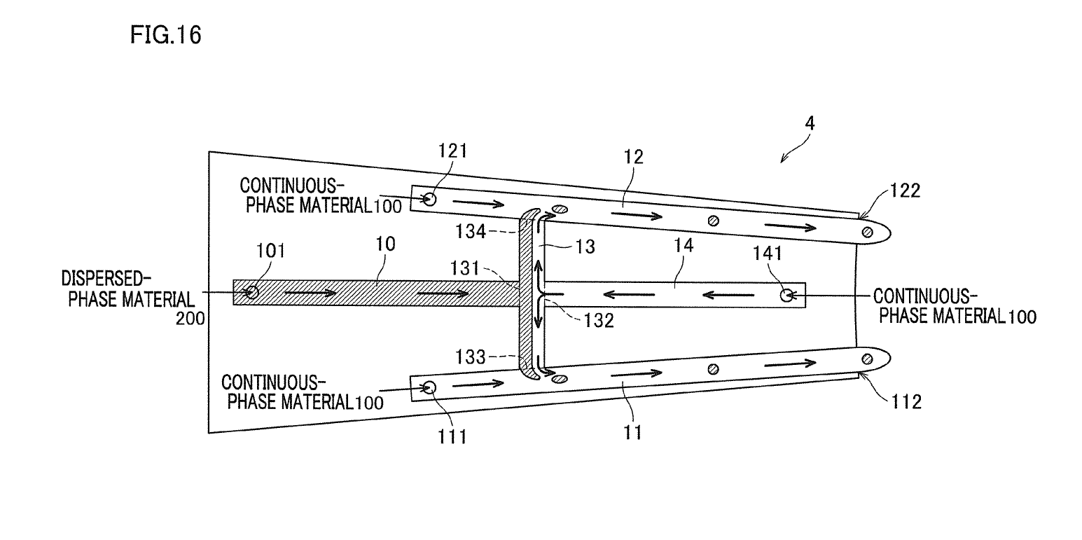

The following describes the process of forming the small particles 202 with reference to FIGS. 15 and 16. FIG. 15 is an explanatory diagram showing a process of producing small particles using the liquid formation unit. FIG. 16 is an explanatory diagram showing a process of forming droplets using the liquid formation unit. For the sake of convenience, FIG. 15 and FIG. 16 each shows merely one liquid formation unit 4 of one droplet formation module 1a; however, the small particles 202 are formed according to the below-described process in all of the liquid formation units 4 (through the droplet formation passages 3) included in the droplet formation device 1.

First, reference is made to FIG. 15. The supply member 601 is coupled to the supply device M1 (FIG. 17) via a tube or the like. In addition, the supply members 701 and 801 are coupled to the supply device M1 (FIG. 17) via the respective tubes. Further, the collection pipes 900 are coupled to a mechanism, a device or the like (e.g., a container 5) used in a posterior step via a tube or the like. The posterior step is different depending on the application of the particles. In production of the small particles 202 used for embolization, the posterior step is cooling, and thereafter, dehydration, cleaning, and crosslinking are carried out.

(Process of Forming Small Particles 202: Droplet Formation Step)

After the droplet formation device 1 is coupled to the supply device M1 (FIG. 17) and to the mechanism, device, or the like (e.g., the container 5) for the posterior step in the above-described manner, gelatin as the dispersed-phase material 200 is then put into water of room temperature for swelling. Next, stirring takes place for approximately 0.5 to 1.5 hours with the use of a stirrer, a mixing blade, a shaker, or the like, thus completely dissolving the gelatin in the warm water of approximately 40° C. to 60° C., thereby to form an aqueous gelatin solution.

Thereafter, olive oil as the continuous-phase material 100 is supplied to the continuous-phase passages 14. To be more specific, the olive oil is supplied to the supply member 701 by the supply device M1 (FIG. 17). The olive oil supplied to the supply member 701 is supplied to the continuous-phase storage parts 2312 through the supply pipes (not shown). The continuous-phase storage parts 2312 store the supplied olive oil. When the amount of olive oil stored in each continuous-phase storage part 2312 exceeds the storage capacity of the continuous-phase storage part 2312, the olive oil is supplied to the continuous-phase passages 14 via the respective continuous-phase material supply parts 141.

Simultaneously with the supply of the olive oil to the continuous-phase passages 14, the olive oil is supplied to the continuous-phase passages 11 and 12. Specifically, the olive oil is supplied to the supply member 801 by the supply device M1 (FIG. 17). The olive oil supplied to the supply member 801 is supplied to the continuous-phase storage parts 2313 through the supply pipes (not shown). The continuous-phase storage parts 2313 store the supplied olive oil. When the amount of olive oil stored in each continuous-phase storage part 2313 exceeds the storage capacity of the continuous-phase storage part 2313, the olive oil is supplied to the continuous-phase passages 11 and 12 via the respective continuous-phase material supply parts 111 and 121. To the continuous-phase passages 11, 12, and 14, the olive oil in the liquid phase is supplied at a predetermined temperature and flow velocity. For example, the predetermined temperature is 40° C., and the predetermined flow volume is 1 ml/h.

Then, after the continuous-phase passages 11, 12, and 14 are filled with the olive oil and the olive oil is discharged in a stable quantity from the discharge ports 112 and 122, the aqueous gelatin solution is supplied to the dispersed-phase passages 10. Specifically, the aqueous gelatin solution is supplied to the supply member 601 by the supply device M1 (FIG. 17). The aqueous gelatin solution supplied to the supply member 601 is supplied to the dispersed-phase storage parts 2314 through the supply pipes (not shown). The dispersed-phase storage parts 2314 store the supplied aqueous gelatin solution. When the amount of aqueous gelatin solution stored in each dispersed-phase storage part 2314 exceeds the storage capacity of the dispersed-phase storage part 2314, the aqueous gelatin solution is supplied to the dispersed-phase passages 10 via the respective dispersed-phase material supply parts 101. To the dispersed-phase passages 10, the aqueous gelatin solution is supplied at a predetermined temperature and flow velocity. For example, the temperature is 40° C., and the flow volume is 1 ml/h. Note that it is preferable that the temperature of the aqueous gelatin solution is same as the temperature of the olive oil to avoid a change in the physical property of the dispersed-phase material 200 in the communication passages 13 and in the continuous-phase passages 11 and 12.

The olive oil and the aqueous gelatin solution are supplied in the above-described manner, and then the aqueous gelatin solution flows from each dispersed-phase material supply part 101 to the corresponding communication opening 131 as shown in FIG. 16. The aqueous gelatin solution flows into the communication passage 13 via the communication opening 131. Meanwhile, in the continuous-phase passage 14, the olive oil supplied through the continuous-phase material supply part 141 flows toward the communication opening 132, and the olive oil flows into the space between the communication opening 131 and the communication opening 132 (the collision space) via the communication opening 132. In the collision space, the aqueous gelatin solution collides with the olive oil entering via the communication opening 132. With this collision, the flows of the aqueous gelatin solution and the olive oil are branched in the collision space, and flow in the form of two layers in two directions toward the communication openings 133 and 134.

The two-layered aqueous gelatin solution and olive oil flow into the continuous-phase passages 11 and 12 via the respective communication openings 133 and 134. In each continuous-phase passage 11, 12, the olive oil is supplied through the corresponding continuous-phase material supply part 111, 121 and flows toward the corresponding discharge port 112, 122. This olive oil flows so as to intersect the flow of the two-layered aqueous gelatin solution and olive oil at the communication opening 133, 134. Therefore, the olive oil flowing through the continuous-phase passage 11, 12 causes the two-layered aqueous gelatin solution and olive oil entering from the communication opening 133, 134 to flow downstream with respect to the direction in which the olive oil flows through the continuous-phase passage 11, 12. At the communication opening 133, 134, the aqueous gelatin solution in the two-layer form flows upstream, with respect to the direction in which the olive oil flows through the continuous-phase passage 11, 12, and the olive oil in the two-layer form flows downstream, with respect to this direction. Accordingly, at the communication opening 133, 134, the aqueous gelatin solution is sandwiched by the olive oil in the two-layer form and the olive oil flowing through the continuous-phase passage 11, 12 from both sides, and thereby sheared by the these flows of olive oil from the both sides, to be formed into droplets.

As described above, in each liquid formation unit 4, the dispersed-phase material 200 flows from the single dispersed-phase passage 10 to the two continuous-phase passages 11 and 12, and therefore, for the single dispersed-phase passage 10, the droplets 201 of the dispersed-phase material 200 are formed through the two continuous-phase passages 11 and 12. Accordingly, compared with a conventional droplet formation passage in which the number of dispersed-phase passages formed have to be the same as that of the plurality of continuous-phase passages, the droplet formation passage 3 is able to maintain the number of droplets 201 formed per unit time while saving the space. Therefore, a larger number of the continuous-phase passages 11 and 12 are formed on the border surface 21a.

Further, each liquid formation unit 4 is configured so that, at each communication opening 133, 134, the aqueous gelatin solution and the olive oil flow in the form of two layers, and the olive oil layer flows downstream with respect to the direction in which the olive oil flows through the continuous-phase passage 11, 12. As described above, the two-layered aqueous gelatin solution and olive oil are pushed by the olive oil flowing through the continuous-phase passage 11, 12 toward a downstream side with respect to the direction in which the olive oil flows through the continuous-phase passage 11, 12. Here, if the olive oil does not flow with the aqueous gelatin solution in the form of two layers, the aqueous gelatin solution is attached to the communication opening 133, 134 (to a downstream edge of the opening (downstream with respect to the direction of the flow in the continuous-phase passage 11, 12)). In the first embodiment, the olive oil flows through the downstream portion of the communication opening 133, 134 (downstream with respect to the direction of the flow in continuous-phase passage 11, 12), and this olive oil prevents the aqueous gelatin solution from being attached to that portion. This suppresses hydrophilization of a wall surface of the passages at the communication openings 133 and 134, and realizes stable formation of droplets over a long period of time.

An emulsion formed of the thus formed droplet 201 and the continuous-phase material 100 is discharged to the single discharge path 2a from each of the discharge ports 112 and 122. The emulsion discharged from the discharge path 2a passes through the corresponding collection pipe 900 to be discharged to the outside of the droplet formation device 1. After the droplets 201 are thus discharged from the droplet formation device 1, the diameters of the droplets 201 are measured using a not-shown particle size distribution measurement device or the like. Then, the flow velocity (flow volume per unit time) and the temperature of the dispersed-phase material 200 and the continuous-phase material 100 are adjusted manually by an operator or automatically, so that the droplets 201 having the same desirable diameter are produced.

(Cooling)

The uniform droplets 201 along with the olive oil are put into olive oil stored in the container 5 having a temperature control mechanism and a stirring mechanism. Here, the temperature of the olive oil in the container 5 has been controlled so as to fall within the range from 0° C. to 60° C., particularly, not more than the gelation temperature of the aqueous gelatin solution. Therefore, gelation of the droplets 201 is started immediately after the droplets 201 are put into the container 5, and the droplets 201 are changed into gel particles 203. This prevents adhesion or cohesion of the droplets 201 with one another, and restrains deformation or division of the gel particles 203 due to an external force stemming from, for example, a collision of the gel particles 203 with one another. In the case where the droplets 201 needs to be cooled down to a temperature equal to or lower than the solidification point of the olive oil (oil) in the cooling step for gelation after the formation of the droplets 201, it is preferable to add (mix) a dehydration solvent (because the solidification point of the solvent is low) into the olive oil stored in the container 5 in advance, i.e., in the stage of forming the droplets (in the droplet formation step). This lowers the solidification point of the mixture in container 5, thereby preventing the solidification of the emulsion.

(Dehydration)

When a predetermined number or a predetermined quantity or more of the gel particles 203 are formed in the container 5, a dehydration solvent at a temperature not more than the gelation temperature is supplied to the container 5 and is mixed with the olive oil in the container 5. Then, mixing by stirring is carried out for at least 15 minutes, to sufficiently dehydrate the gel particles 203. This prevents the cohesion of the gel particles 203 with one another, and changes the gel particles 203 into dehydrated particles 204 subjectable to uniform crosslinking in a posterior step. Examples of the dehydration solvent include: a ketone based solvent such as acetone; an alcohol based solvent such as isopropyl alcohol; an ester based solvent such as ethyl acetate; a hydrocarbon based solvent such as toluene and hexane; a halogen based solvent such as dichloroethane, and the like.

(Cleaning)

Simultaneously with the dehydration step, or before or after the dehydration step, cleaning is carried out. In the cleaning step, a poor solvent which does not dissolve the gelatin is supplied to the container 5, and the dehydrated particles 204 are cleaned using the poor solvent. The poor solvent is preferably used at a temperature not more than the gelation temperature of the gelatin. Examples of the poor solvent which does not dissolve the gelatin include: a ketone based solvent such as acetone; an alcohol based solvent such as isopropyl alcohol; and the like. Where one cycle of operation of cleaning is cleaning of 15 to 30 minutes using approximately 200 to 300 ml of the solvent, four to six cycles of operation are preferably carried out for approximately 2 to 15 grams of the gel particles 203 (or the dehydrated particles 204).

(Drying)

Next, the dehydrated particles 204 are taken out from the container 5, and the dehydrated particles 204 are dried at a temperature which does not cause melting of the gelatin. This removes the cleaning solvent on the dehydrated particles 204, and removes water in the dehydrated particles 204, thereby forming the dehydrated particles 204 into dry particles 205. Various methods are adoptable as the method for drying, such as forced-air drying, vacuum drying, freeze drying, or the like. In the drying step, it is preferable to dry the dehydrated particles 204 for 12 hours or longer at a temperature ranging, for example, from 5° C. to 25° C., and it is more preferable to dry the particles under a depressurized atmosphere.

(Crosslinking)

Next, the dry particles 205 are heated for 0.5 to 120 hours at a temperature ranging from 80° C. to 250° C. For the small particles 202 used as embolus particles, the conditions for heating are determined depending on the time needed to completely decompose the small particles 202 in a blood vessel, that is, the period of time needed from the point of blocking the blood vessel with the small particles 202 to the point of resuming the blood flow in the blood vessel. The heating period is dependent on the heating temperature. In general, to necrotize a tumor (cancer), the blood vessel needs to be blocked for 2 to 3 days. Therefore, for 3 to 7 days of decomposition period of the small particles 202, for example, the crosslinking conditions are preferably as follows: the dry particles 205 are heated at a temperature ranging from 100° C. to 180° C., for a period of time not less than 1 hour and not more than 24 hours. For the use of the small particles 202 in a drug delivery system, it is preferable to determine the heating conditions depending on the period of sustained release of a medicinal substance in a body. To avoid a problem such as oxidization of the dry particles 205, the crosslinking step is preferably carried out under a depressurized atmosphere, or under an inert gas atmosphere.

(Droplet Formation System)

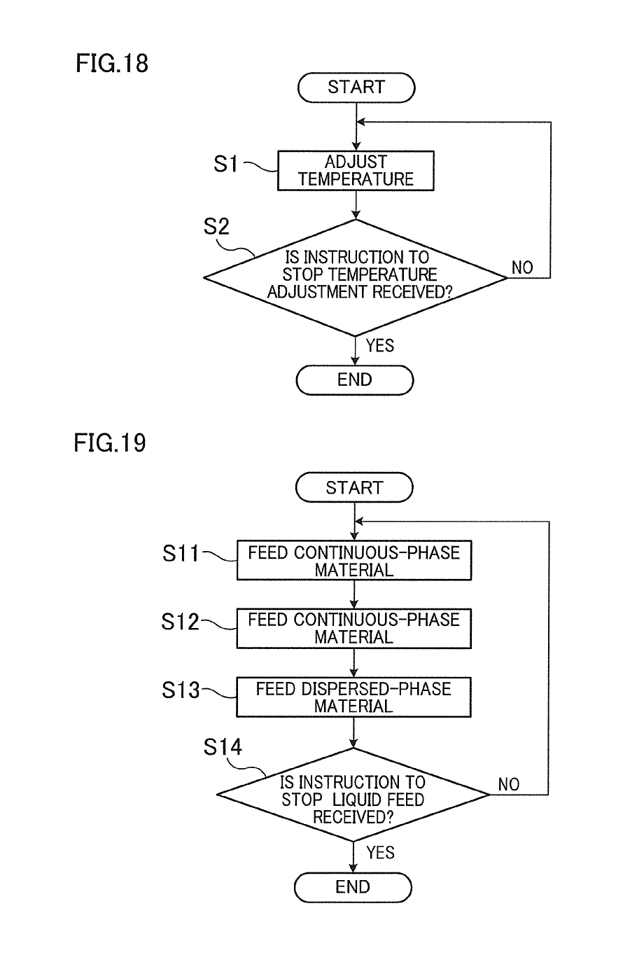

The following describes a droplet formation system M10 which includes the droplet formation device 1, the supply device M1, and a control device M2, with reference to FIGS. 17 and 18. FIG. 17 is a block diagram showing an electrical structure of the droplet formation system.

The supply device M1 includes a dispersed-phase material pump M11, a continuous-phase material pump M12, a continuous-phase material pump M13, a dispersed-phase material temperature regulator M14, a continuous-phase material temperature regulator M15, a continuous-phase material temperature regulator M16, a temperature sensor M17, a temperature sensor M18, and a temperature sensor M19. The dispersed-phase material pump M11 is a pump for supplying the dispersed-phase material 200 to the supply member 601 from the not-shown storage tank for the dispersed-phase material 200 included in the supply device M1. The continuous-phase material pump M12 is a pump for supplying the continuous-phase material 100 to the supply member 701 from the not-shown storage tank for the continuous-phase material 100 included in the supply device M1. The continuous-phase material pump M13 is a pump for supplying the continuous-phase material 100 to the supply member 801 from another not-shown storage tank for the continuous-phase material 100 included in the supply device M1.

The dispersed-phase material temperature regulator M14 is attached to the not-shown storage tank for the dispersed-phase material 200, and it is a heater or the like for adjusting the temperature of the dispersed-phase material 200 in the not-shown storage tank to a predetermined temperature. The continuous-phase material temperature regulator M15 is attached to the not-shown storage tank for the continuous-phase material 100, and it is a heater or the like for adjusting the temperature of the continuous-phase material 100 in the not-shown storage tank to a predetermined temperature. The continuous-phase material temperature regulator M16 is attached to the other not-shown storage tank for the continuous-phase material 100, and it is a heater or the like for adjusting the temperature of the continuous-phase material 100 in the not-shown storage tank to a predetermined temperature.

Further, the temperature sensor M17 is attached to the storage tank for the dispersed-phase material 200, and it is a sensor for detecting the temperature of the dispersed-phase material 200 in the storage tank. The temperature sensor M18 is attached to the storage tank for the continuous-phase material 100, and it is a sensor for detecting the temperature of the continuous-phase material 100 in the storage tank. The temperature sensor M18 is attached to the other storage tank for the continuous-phase material 100, and it is a sensor for detecting the temperature of the continuous-phase material 100 in the other storage tank.

The control device M2 is a device for controlling the supply of the continuous-phase material 100 and the dispersed-phase material 200 by the supply device M1 to the droplet formation device 1. The control device M2 includes a CPU (Central Processing Unit) M21, a monitor M22, an operation unit M23, a memory unit 24, and an input unit 25. To the CPU M21, detection signals from the temperature sensors M17, M18, and M19 are input via the input unit 25, and the CPU M21 executes a temperature adjustment process, which will be described later, based on the input detection signals. In the temperature adjustment process, temperature settings of the dispersed-phase material temperature regulator M14, the continuous-phase material temperature regulator M15, and the continuous-phase material temperature regulator M16 are controlled, thereby to adjust the temperatures of the continuous-phase material 100 and the dispersed-phase material 200 to be supplied to the droplet formation device 1.

Further, the CPU M21 executes a liquid feed process, and thereby controls the supply of the continuous-phase material 100 and the dispersed-phase material 200 to the droplet formation device 1 by the dispersed-phase material pump M11, the continuous-phase material pump M12, and the continuous-phase material pump M13. With this, the dispersed-phase material 200 is supplied to the dispersed-phase passages 10, and the continuous-phase material 100 is supplied to the continuous-phase passages 11, 12, and 14, at predetermined flow volumes and flow velocities, respectively.

The monitor M22 is a monitor for displaying the currently-set amount of the dispersed-phase material 200 supplied to the supply member 601 and the currently-set amounts of the continuous-phase material 100 supplied to the supply members 701 and 801. The monitor M22 also displays the current target temperature of the dispersed-phase material 200 in the not-shown storage tank for the dispersed-phase material 200, and the current target temperatures of the continuous-phase material 100 in the two not-shown storage tanks for the continuous-phase material 100.

The operation unit M23 receives input from an operator. The operation unit M23 has three adjustment knobs and the like configured to be operated by the operator. The three adjustment knobs respectively associated with the supply members 601, 701, and 801. To each supply member 601, 701, 801, supplied is the continuous-phase material 100 or the dispersed-phase material 200, whose amount corresponds to the degree of rotation of the corresponding adjustment knob.

The operation unit M23 further includes a touch panel, a keyboard, or the like. Based on an input by the operator, which is received through the touch panel, keyboard, or the like, the target temperature of the dispersed-phase material 200 in the not-shown storage tank for the dispersed-phase material 200 and the target temperatures of the continuous-phase material 100 in the not-shown storage tanks for the continuous-phase material 100 are set. Based on the thus set temperatures and the detection signals from the temperature sensors M17, M18, and M19, the CPU M21 determines the temperature settings of the dispersed-phase material temperature regulator M14 and of the continuous-phase material temperature regulators M15 and M16.

Further, the memory unit 24, which is a RAM or the like, for example, stores the current target temperature of the dispersed-phase material 200 in the not-shown storage tank for the dispersed-phase material 200, and also stores the current target temperatures of the continuous-phase material 100 in the two not-shown storage tanks for the continuous-phase material 100. Moreover, the memory unit 25 stores the currently-set amount of the dispersed-phase material 200 to be supplied to the supply member 601, and the currently-set amounts of the continuous-phase material 100 to be respectively supplied to the supply members 701 and 801. The input unit 25 receives detection signals from the temperature sensors M17, M18, and M19, and outputs digital signals to the CPU M21 after converting the detection signals to the digital signals.

(Droplet Formation System: Temperature Adjustment Process)

The following describes an example of the temperature adjustment process executed by the droplet formation system M10 with reference to FIGS. 17 and 18. FIG. 18 is a flow chart showing an example of the temperature adjustment process executed by the droplet formation system. First, the CPU M21 adjusts the temperature settings of the dispersed-phase material temperature regulator M14, the continuous-phase material temperature regulator M15, and the continuous-phase material temperature regulator M16 (S1). To be more specific, the CPU M21 reads out, from the memory unit 25, the current target temperature of the dispersed-phase material 200 in the not-shown storage tank for the dispersed-phase material 200. Then, the CPU M21 adjusts the temperature setting of the dispersed-phase material temperature regulator M14 based on the detection signal from the temperature sensor M17 so that the temperature of the material in the not-shown storage tank for the dispersed-phase material 200 becomes equal to the read out target temperature.

Further, the CPU M21 reads out, from the memory unit 25, the current target temperatures of the continuous-phase material 100 in the respective two storage tanks (not shown) for the continuous-phase material 100. Then, the CPU M21 adjusts the temperature settings of the continuous-phase material temperature regulators M15 and M16 based on the detection signals from the temperature sensors M18 and M19, respectively, so that the temperatures of the material in the respective two storage tanks (not shown) for the continuous-phase material 100 become equal to the read out target temperatures, respectively.

Thereafter, the CPU M21 determines whether the operation unit M23 receives an instruction to stop the temperature adjustment process (S2). When it is determined that the instruction has been received (S2: YES), the CPU M21 ends the temperature adjustment process. When it is determined that the instruction is not received (S2: NO), the CPU M21 returns the processing to Step S1. That is, Step S1 is repeated at predetermined time intervals until it is determined in Step S2 that the instruction is not received. With this temperature adjustment process, the dispersed-phase material 200 and the continuous-phase material 100 are supplied to the droplet formation device 1 at respective temperatures arbitrarily determined by the operator.

The following describes an example of the temperature adjustment process executed by the droplet formation system M10 with reference to FIGS. 17 and 19. FIG. 19 is a flow chart showing an example of the liquid feed process executed by the droplet formation system. First, the CPU M21 controls feeding of the continuous-phase material 100 carried out by the continuous-phase material pump M12 (S11). To be more specific, the CPU M21 controls the operation of the continuous-phase material pump M12 so that the continuous-phase material 100 whose amount corresponds to the operation on the operation unit M23 is supplied to the supply member 701.

Then, the CPU M21 controls feeding of the continuous-phase material 100 carried out by the continuous-phase material pump M13 (S12). To be more specific, the CPU M21 controls the operation of the continuous-phase material pump M13 so that the continuous-phase material 100 whose amount corresponds to the operation on the operation unit M23 is supplied to the supply member 801. Subsequently, the CPU M21 controls feeding of the dispersed-phase material 200 carried out by the dispersed-phase material pump M11 (S13). To be more specific, the CPU M21 controls the operation of the dispersed-phase material pump M11 so that the dispersed-phase material 200 whose amount corresponds to the operation on the operation unit M23 is supplied to the supply member 601.

Thereafter, the CPU M21 determines whether an instruction to stop the liquid feed process is received through the operation unit M23 (S14). When it is determined that the instruction has been received (S14: YES), the CPU M21 ends the liquid feed process. When it is determined that the instruction to stop the liquid feed process is not received (S14: NO), the CPU M21 returns the processing to Step S11. That is, Steps S11 to S14 are repeated at predetermined time intervals, until it is determined in Step S14 that the instruction is not received. With this liquid feed process, the dispersed-phase material 200 is supplied to the dispersed-phase passages 10 and the continuous-phase material 100 is supplied to the continuous-phase passages 11, 12, and 14, at respective flow velocities and flow volumes arbitrarily determined by the operator.

As described above, in the droplet formation device 1 of this embodiment, the dispersed-phase storage parts 2314 and the continuous-phase storage parts 2312 and 2313 are formed on the same single substrate, that is, the lower substrate 23. In addition, the passage structures 211 are formed on the middle substrate 21. Thus, the main elements for forming the droplets 201 are formed on the two substrates which are the middle substrate 21 and the lower substrate 23, and this allows the droplet formation device 1 to have the smaller number of components and to be easily disassembled and easily assembled. Further, the dispersed-phase storage parts 2314 and the continuous-phase storage parts 2312 and 2313 are formed in the base member 2. Therefore, the manner of providing the dispersed-phase material supply parts 101 and the manner of providing the continuous-phase material supply parts 111, 121, and 141 are simplified, compared with the conventional art where: elements corresponding to these storage parts are provided outside the base member; and the continuous-phase material supply part for supplying the continuous-phase material from the continuous-phase storage part to each droplet formation passage of the passage structures and the dispersed-phase material supply part for supplying the dispersed-phase material from the dispersed-phase storage part to each droplet formation passage of the passage structures are provided so as to pass the respective through holes in the base member. This also allows the droplet formation device 1 to be disassembled easily and assembled easily.

Thus, the embodiment has been described above. However, the above embodiment solely serves as a specific example, and by all means does not limit the present invention. Specific structure or the like are modifiable as needed. Further, the functions and effects described in the embodiment are no more than examples given as the most preferable functions and effects brought about by the present invention, and the functions and effects of the present invention are not limited to those described in the embodiment of the present invention.

The droplet formation device of this embodiment of the present invention may have any other structure as long as the droplet formation device includes: a base member formed of a plurality of substrates including a first substrate and a second substrate; a passage structure formed on the first substrate, the passage structure including a plurality of droplet formation passages through which a liquid of a dispersed-phase material and a liquid of a continuous-phase material flow to form droplets of the dispersed-phase material by using a shear force of the continuous-phase material; a dispersed-phase storage part which is formed on the second substrate and is configured to store the liquid of the dispersed-phase material; a continuous-phase storage part which is formed on the second substrate and is configured to store the liquid of the continuous-phase material; dispersed-phase material supply parts through which the dispersed-phase material is supplied from the dispersed-phase storage part to the droplet formation passages of the passage structure; and continuous-phase material supply parts through which the continuous-phase material is supplied from the continuous-phase storage part to the droplet formation passages of the passage structure.

### First Modification of Embodiment

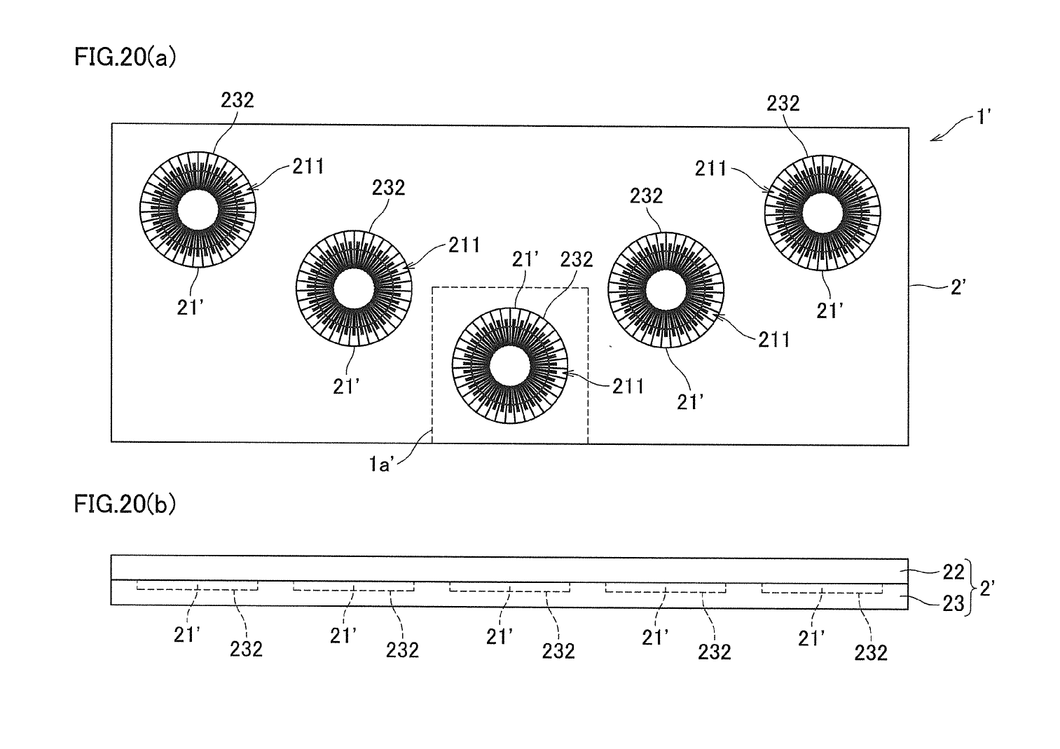

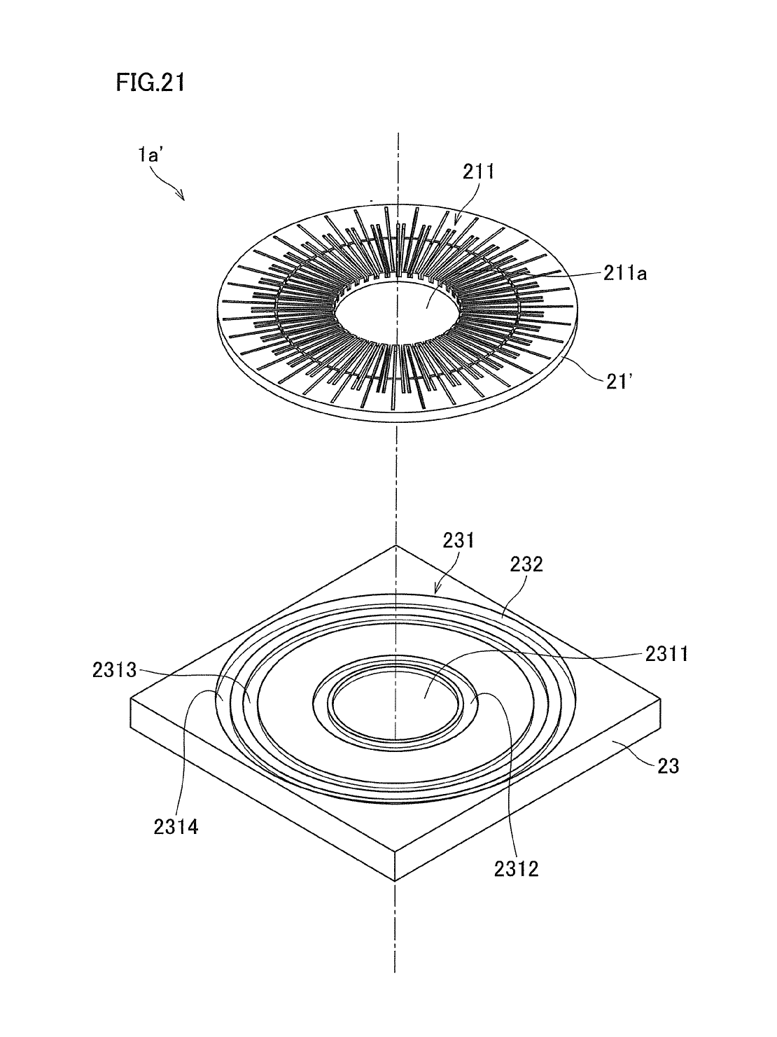

The following describes a first modification of the above embodiment with reference to FIGS. 20 and 21. FIG. 20(a) is a plan view of a droplet formation device of the first modification of the above embodiment, and FIG. 20(b) is a side view of a base member of the droplet formation device of the first modification. Note that in FIG. 20 (b), middle substrates 21′ and holes 232 which are actually invisible and will be described later are illustrated by dotted lines, for the convenience of description. FIG. 21 is an exploded view of a droplet formation module of the first modification.

In the above embodiment, the base member 2 is formed of the middle substrate 21, the upper substrate 22, and the lower substrate 23 stacked on one another, each of which substrates has the similar shape in a plan view. On the other hand, in a base member 2′ of a droplet formation device 1′ of the first modification, five middle substrates 21′ each having a disc-like shape in a plan view are respectively embedded in five holes 232 each having a circular shape in a plan view and formed on a surface of the lower substrate 23. In each droplet formation module 1′, the middle substrate 21′ and the hole 232 are formed so that their respective shapes substantially match with each other for the tight fit of the middle substrate 21′ in the hole 232. The middle substrates 21′ are detachably fitted in the respective holes 232.

In each hole 232, the liquid storage part 231 is formed in the same way as in the above embodiment, and the second discharge path 2311 is formed at the center of the liquid storage part 231. In each middle substrate 21′, the single first discharge path 211a is formed at the center of the middle substrate 21′, and the passage structure 211 is formed around the first discharge path 211a. As for the shapes of each passage structure 211, each liquid storage part 231, each dispersed-phase material supply part 101, each continuous-phase material supply part 111, 121, 141, each discharge port 112, 122, and the like, description is omitted here since they are similar to those in the above embodiment.

The droplet formation device 1′ of the above-described first modification, and also of a second modification, brings about the functions and effects similar to those of the above embodiment. Further, in the droplet formation device 1′ of the first modification, it is possible to easily customize the shape of each passage structure 211 of the droplet formation device 1′ by: preparing multiple types of middle substrates 21′ each type having the passage structure 211 different from others in shape; and changing the type of the middle substrate (s) 21′ to be attached to the droplet formation device 1′. For example, in accordance with the needs of a user, the droplet formation device 1′ is able to be customized so as to form droplets 201 of different sizes by attaching different types of middle substrates 21′ to the droplet formation device 1′. Thus, the droplet formation device 1′ of the first modification allows the user to customize the droplet formation device 1′ easily with wide variations.

### Second Modification of Embodiment

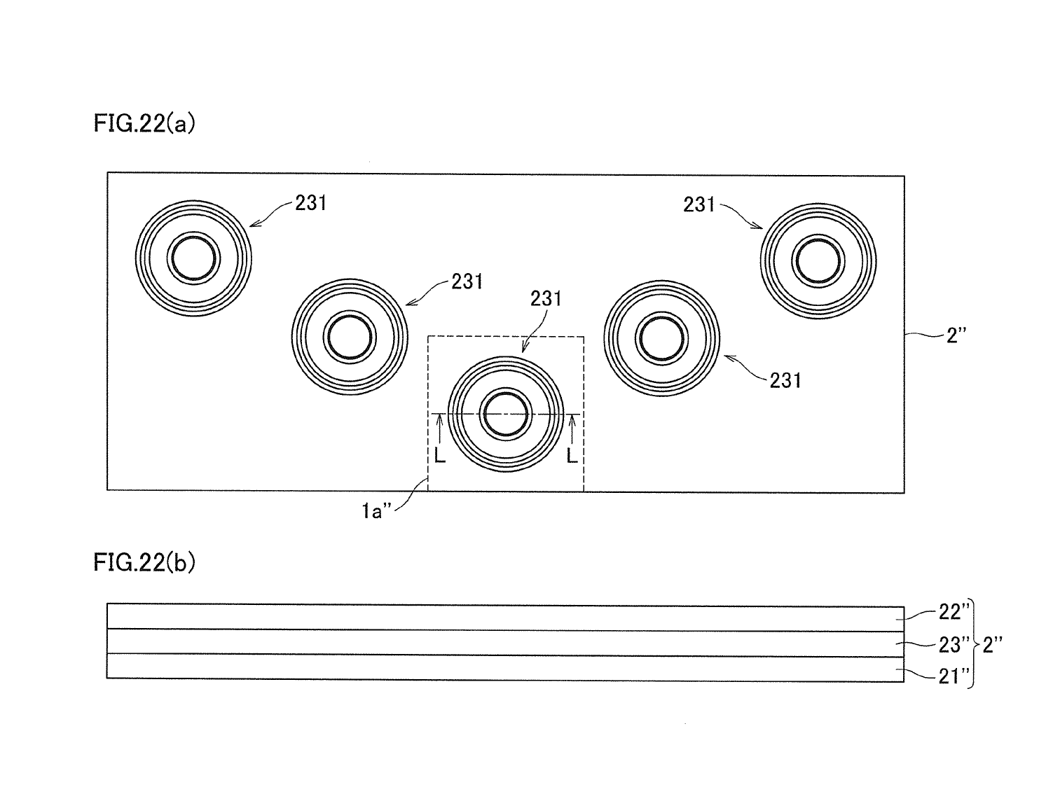

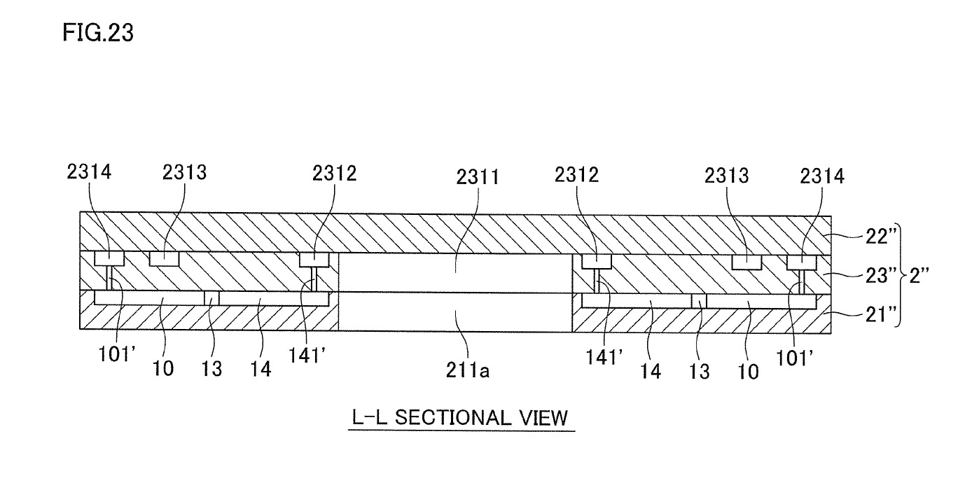

The following describes a second modification of the above embodiment with reference to FIGS. 22 and 23. FIG. 22(a) is a plan view of a droplet formation device of the second modification of the above embodiment, and FIG. 22(b) is a side view of a base member of the droplet formation device of the second modification. FIG. 23 is a sectional view of a droplet formation module taken along a line L-L in FIG. 22(a).

In the base member 2 of the above embodiment, the passage structures 211 are formed on the middle substrate 21 to be stacked on (to be positioned higher than) the lower substrate 23, and the liquid storage part 231 are formed on the lower substrate 23. On the other hand, in a base member 2″ of a droplet formation device 1″ of the second modification, a second substrate 23″ having the liquid storage parts 231 is stacked on (is positioned higher than) a first substrate 21″ having the passage structures 211. Further, the upper substrate 22 is stacked on the second substrate 23″. As described above, since the upper substrate 22 is transparent, the surface of the second substrate 23″ on which the liquid storage parts 231 are formed is visible through the upper substrate 22, as shown in FIG. 22.

Continuous-phase material supply parts 111′, 121′, and 141′ are through holes formed below each liquid storage part 231 in the first substrate. To be more specific, the upper end of each continuous-phase material supply part 111′ communicates with the associated continuous-phase storage part 2313, and the lower end of each continuous-phase material supply part 111′ communicates with the corresponding continuous-phase passage 11. The upper end of each continuous-phase material supply part 121′ communicates with the associated continuous-phase storage part 2313, and the lower end of each continuous-phase material supply part 121′ communicates with the corresponding continuous-phase passage 12. Further, the upper end of each continuous-phase material supply part 141′ communicates with the continuous-phase material storage part 2312, and the lower end of each continuous-phase material supply part 141′ communicates with the corresponding continuous-phase passage 14.

Dispersed-phase material supply parts 101′ are through holes formed below each liquid storage part 231 in the first substrate. To be more specific, the upper end of each dispersed-phase material supply part 101′ communicates with the associated dispersed-phase storage part 2314, and the lower end of each dispersed-phase material supply part 101′ communicates with the corresponding dispersed-phase passage 10.

The continuous-phase material 100 and the dispersed-phase material 200 stored in each liquid storage part 231 flow downward through the continuous-phase material supply parts 111′, 121′, and 141′, and the dispersed-phase material supply parts 101′, respectively, and flow into the corresponding passage structure 211. It should be noted that the other elements of the droplet formation device 1′ are similar to those in the above embodiment, and therefore, the description thereof is omitted.

Also in the above-described second modification, the functions and effects similar to those of the above embodiment are brought about.

### Other Modifications

The structure of each droplet formation passage 3 is not limited to that in the above embodiment, and any other structures may be adopted. For example, any of the following structures may be adopted as the structure of the droplet formation passage 3.

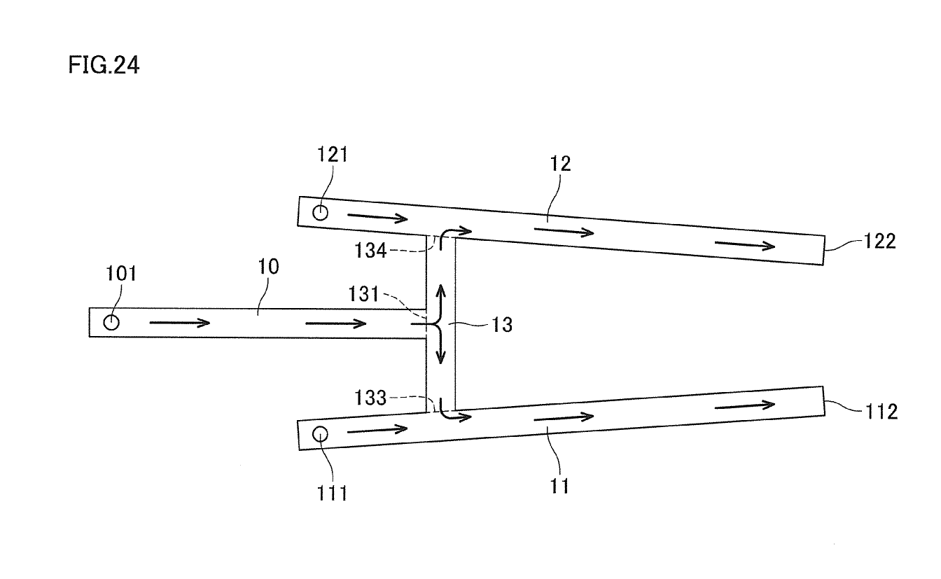

(1) For example, as shown in a modification of FIG. 24, the continuous-phase passage 14 does not have to be formed. FIG. 24 is a plan view of a droplet formation passage of a modification of the above embodiment.

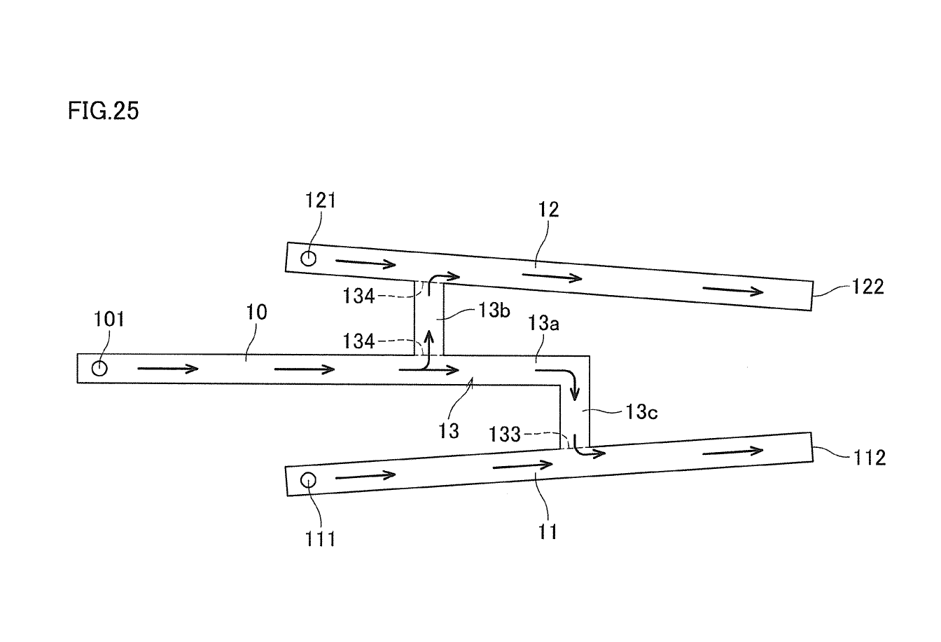

(2) Although the communication passage 13 is formed so as to extend straight in each droplet formation passage 3 of the above embodiment, the communication passage 13 may have another configuration. For example, as in another modification shown in FIG. 25, the communication passage 13 may have a bent portion. FIG. 25 is a plan view of a droplet formation passage of that another modification of the above embodiment. The communication passage 13 of each droplet formation passage of this modification includes: a first passage 13a which is formed collinearly with the dispersed-phase passage 10 and communicates with the downstream end of the dispersed-phase passage 10; a second passage 13b which is formed so as to extend from the upstream end of the first passage 13a toward the continuous-phase passage 12 and allows the continuous-phase passage 12 to communicate with the dispersed-phase passage 10; and a third passage 13c which is formed so as to extend from the downstream end of the first passage 13b toward the continuous-phase passage 11 and allows the continuous-phase passage 11 to communicate with the dispersed-phase passage 10.

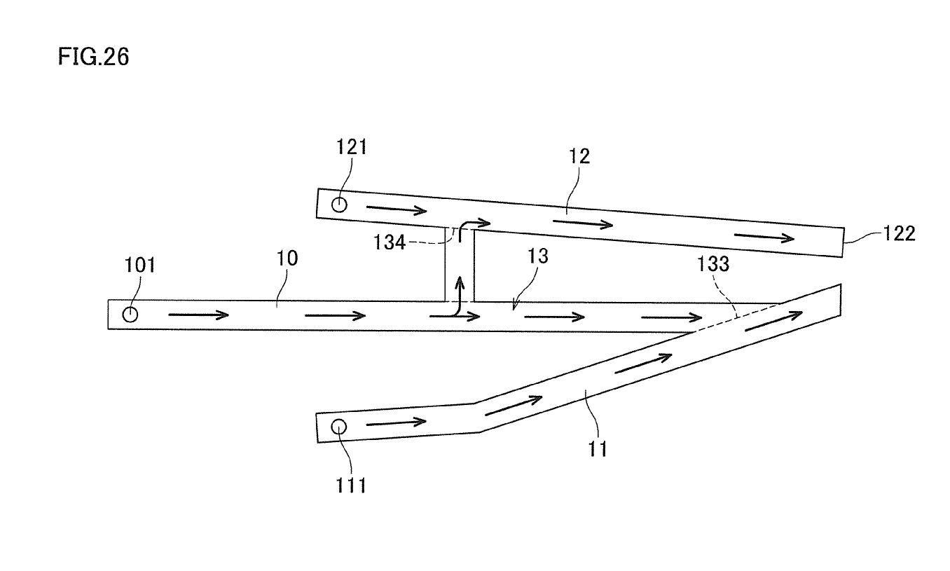

(3) The continuous-phase passages 11 and 12 of each pair are almost parallel to each other in the above embodiment; however, they do not have to be almost parallel to each other, as in another modification shown in FIG. 26, for example. FIG. 26 is a plan view of a droplet formation passage of that another modification of the above embodiment. In the droplet formation passage of this modification, the continuous-phase passage 11 is bent in its intermediate portion, and the continuous-phase passage 11 and the continuous-phase passage 12 are not substantially parallel to each other.

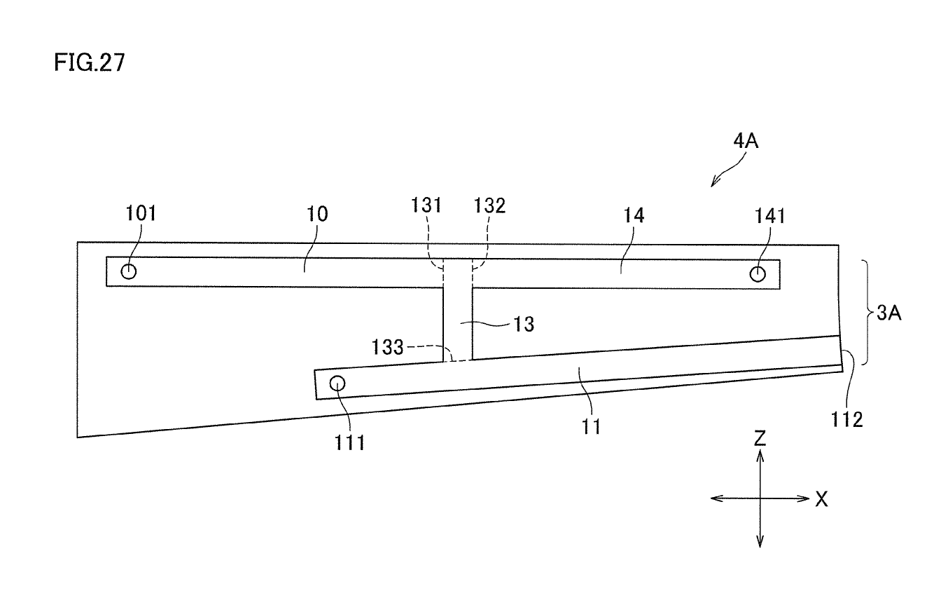

(4) Further, as shown in FIG. 27, each droplet formation passage 3 may have just either one of the continuous-phase passages 11 and 12. FIG. 27 is a plan view of a liquid formation unit of still another modification of the above embodiment. Each droplet formation passage 3A of a liquid formation unit 4A of this modification has the continuous-phase passage 11 of the continuous-phase passages 11 and 12, but does not have the continuous-phase passage 12. In the droplet formation passage 3A, the communication passage 13A establishes communication between the dispersed-phase passage 10 and the continuous-phase passage 11 via the communication opening 133. A side surface of the communication passage 13A which surface is opposed to the communication opening 133 is formed on the same plane with a side surface of the dispersed-phase passage 10 which surface is farther from the continuous-phase passage 11 with respect to the depth direction.

### REFERENCE SIGNS LIST

1, 1′, 1″ droplet formation device
1a, 1a′, 1a″ droplet formation module
2 base member
2a discharge path
21, 21′ middle substrate (first substrate)
21″ first substrate
22 upper substrate
23, 23′ lower substrate (second substrate)
23″ second substrate
3, 3A droplet formation passage
4, 4A liquid formation unit
5 container
10 dispersed-phase passage
100 continuous-phase material
101, 101′ dispersed-phase material supply part
11, 12, 14 continuous-phase passage
111, 111′ continuous-phase material supply part
121, 121′ continuous-phase material supply part
141, 141′ continuous-phase material supply part
112, 122 discharge port
13, 13A communication passage
131, 132, 133, 134 communication opening
200 dispersed-phase material
201 droplet
202 small particle
203 gel particle
204 dehydrated particle
205 dry particle
211 passage structure
211a first discharge path
231 liquid storage part
2311 second discharge path
2312 continuous-phase storage part
2313 continuous-phase storage part
2314 dispersed-phase storage part

1. A droplet formation device comprising:
a base member formed of a plurality of substrates including a first substrate and a second substrate;
a passage structure formed on the first substrate, the passage structure including a plurality of droplet formation passages through which a liquid of a dispersed-phase material and a liquid of a continuous-phase material flow to form droplets of the dispersed-phase material by using a shear force of the continuous-phase material;
a dispersed-phase storage part which is formed on the second substrate and is configured to store the liquid of the dispersed-phase material;
a continuous-phase storage part which is formed on the second substrate and is configured to store the liquid of the continuous-phase material;
dispersed-phase material supply parts through which the dispersed-phase material is supplied from the dispersed-phase storage part to the droplet formation passages of the passage structure; and
continuous-phase material supply parts through which the continuous-phase material is supplied from the continuous-phase storage part to the droplet formation passages of the passage structure.

2. The droplet formation device according to claim 1, wherein:
the passage structure comprises a plurality of passage structures; and
the continuous-phase storage part comprises a plurality of the continuous-phase storage parts which are formed on the second substrate and are configured to store the continuous-phase material to be supplied to the plurality of passage structures, and the dispersed-phase storage part comprises a plurality of the dispersed-phase storage parts which are formed on the second substrate and are configured to store the dispersed-phase material to be supplied to the plurality of passage structures.

3. The droplet formation device according to claim 1, wherein:
the droplet formation passages in the passage structure are arranged annularly; and
each of the continuous-phase storage part and the dispersed-phase storage part is formed on the second substrate into a substantially circular shape in a plan view so as to correspond to an arrangement of the droplet formation passages.

4. The droplet formation device according to claim 1, wherein
the dispersed-phase material supply parts and the continuous-phase material supply parts are through holes formed in the first substrate or the second substrate.

5. The droplet formation device according to claim 1, wherein
the passage structure comprises a plurality of passage structures on a same horizontal plane.

6. The droplet formation device according to claim 1, wherein:
a discharge path through which the droplets of the dispersed-phase material formed through the droplet formation passages of the passage structure are discharged to an outside of the base member is formed in the base member so that the discharge path corresponds to the passage structure in number.

7. The droplet formation device according to claim 6, wherein
the discharge path includes a first discharge path which is a through hole formed in the first substrate, and a second discharge path formed in the second substrate.
